(19) United States
(12) Patent Application Publication
(10) Pub. No.: US 2021/0287274 A1
(43) Pub. Date: Sep. 16, 2021

(54) METHODS AND SYSTEMS FOR A ALL-IN-ONE PERSONAL FASHION COACHING AND ASSISTANCE USING ARTIFICIAL INTELLIGENCE AND PEER-TO-PEER NETWORK DATABASES

(71) Applicant: HAI VIET NGUYEN, ONTARIO (CA)

(72) Inventors: LAM NGOC NGUYEN, HO CHI MINH (VN); PHUONG MINH DAM TRAN, HO CHI MINH (VN); HAI VIET NGUYEN, ONTARIO (CA); GIA HOANG DANG, HO CHI MINH (VN); QUANG VAN DUONG, QUANG NAM (VN)

(73) Assignee: HAI VIET NGUYEN, ONTARIO (CA)

(21) Appl. No.: 16/817,629

(22) Filed: Mar. 13, 2020

(51) Int. Cl. G06Q 30/06; G06T 17/00; G06N 3/04; G06T 7/10

(52) U.S. Cl. CPC G06Q 30/0631; G06Q 30/0621; G06Q 30/0639; G06T 7/10; G06T 17/00; G06N 3/04; G06Q 30/0643

(57) ABSTRACT

A method and system for providing an all-in-one personal fashion coaching and assistance readily to be used on a communication device of a user are disclosed, which includes: (a) providing clothing fitness services use after receiving input images and personal parameters from users; (b) providing try-on services using the body model and measurements and input images of F&A items; (c) providing smart style services by matching input images of F&A items extracted from past and current fashion and apparel (F&A) image files exchanged in a peer-to-peer manner among users and sellers; (d) providing a recommendation services to users by finding fashion trends, stores, locations, and suitable discounted prices.

### FIELD OF THE INVENTION

The present invention relates generally to an automated fashion assistance. More specifically, the present invention relates to a smart fashion coaching and assistance using artificial intelligence and deep learning network.

### BACKGROUND ART

Even though artificial intelligence-based fashion image analyses have huge potential in the fashion and apparel (F&A) industry, they still remain in the research phase. In addition, the researches in the F&A industry are scattered in different applications and mainly focus on the supply chain, i.e., retailers and sellers. That is, the applications of AI have been recognized in the F&A industry at various stages such as apparel design, pattern making, forecasting sales production, supply chain management. On the buyer side, the AI-based researches and applications are scattered to different single applications. For example, there are body measurement applications separate from virtual try-on applications which are separate from e-shopping applications, etc. These applications are not packaged into one single application to provide buyers a complete service that increases buyer's utility and reduces waste.

While the artificial intelligence (AI) is still in a state of researching and has separate applications to buyers, the fashion and apparel (F&A) industry is one of the largest economy contributing 38% to the Asia Pacific, 26% to Europe and 22% to North America. According to Business of Fashion in 2019, F&A sales are projected to grow by 7.5% and 5.5% in the Asia Pacific and Europe respectively. F&A industry is also one of largest waste producers globally because problems like overproduction, product returns, and wastes from unfit clothing, out of fashion clothing collections. Without a complete personal fashion coaching and assistance, consumers waste a lot of money to buy unfit and out of date clothes that are either worn once or twice or never worn, resulting in unnecessary productions and purchases that result in wastes.

Examples of software applications that can only provide a single service (application) to buyers include DeepFashion, DeepFashion 2, Match R-CNN, Mask R-CNN, Fashion++, Catchoom, etc. These software do not provide a complete fashion coaching and assistances to consumers. DeepFashion and DeepFAshion 2 are fashion image recognition engines because they have comprehensive fashion datasets which contain 491K diverse images of 13 popular clothing categories from both commercial shopping stores and consumers. DeepFashion 2 totally has 801K clothing items, where each item in an image is labeled with scale, occlusion, zoom-in, viewpoint, category, style, bounding box, dense landmarks and per-pixel mask. There are also 873K Commercial-consumer clothes pairs. The DeepFashion 2 dataset is split into a training set having 391K images, a validation set having 34k images), and a test set having 67k images.

Match R-CNN and Mask R-CNN are computer vision software that uses convolutional neural network (CNN) algorithms to identify objects or images by performing multiple convolutional layers in parallel. Fashion++ system uses a deep image-generation neural network to recognize garments and offer suggestions on what to remove, add, or swap. It can also recommend ways to adjust a piece of clothing, such as tucking in a shirt or rolling up the sleeves. Whereas previous work in this area has explored ways to recommend an entirely new outfit or to identify garments that are similar to one another, Fashion++ instead aims to suggest subtle alterations to an existing outfit that will make it more style.

The current F&A researches use the centralized computing network to carry out the above listed algorithms. In this architecture, the centralized computations are done at a central location which is a central server. End-users must have the permission of the central server to use the F&A software applications. Because of this, the AI-based applications are limited and cannot be combined into a single all-in-one services due to the limited resources of the centralized network and high maintenance costs. Furthermore, users cannot freely share their personal fashion collections and computing resources to cut costs, wastes, and computation times.

Therefore what is needed is a method and system that provide a complete and synergetic fashion & apparel (F&A) coaching and assistance to consumers using artificial intelligence and machine learning that provide the following all-in-one services to the consumers: (1) how do specific F&A items fit a consumer; (2) how do specific F&A items look on a consumer; (3) how do consumers receive mix and match F&A items that fit their style; (4) how do consumers find nearest retailer stores that offer discounts to F&A items that the consumers like; (5) how do consumers receive latest fashion trends that fit his or her style that are displayed on communication devices, e.g., smart phones or the likes; and (6) what are the body models and measurements of a particular customer.

What is needed is a method and system for personal fashion coaching and assistance that are all-in-one and at the fingertips of the consumers in a single software application (app) or website displayed on communication devices.

What is needed is method and system for personal fashion coaching and assistance that can substantially reduce search costs and wasteful F&A items for consumers, reducing wastes and environmental hazards.

What is needed is method and system for personal fashion coaching and assistance that peer-to-peer connect consumers and retailers together so that personal fashion collections and computation power can be shared.

What is needed is program and system that use artificial intelligence (AI), machine learning (ML), convolutional neural networks (CNN), and computer visions to provide the compact personal fashion coaching and assistance package as described above in a single software application (app) or website displayed on communication devices of end-users.

The method and system of the present invention provide the solutions to the above problems and issues.

### SUMMARY OF THE INVENTION

Accordingly, an object of the present invention is to provide a software and/or hardware for providing an all-in-one personal fashion coaching and assistance readily to be used on a communication device of a user are disclosed, which includes: a plurality of user communication devices each having at least one user databases; a plurality of seller communication devices each having at least one seller databases; a network; and an artificial intelligence (AI) based fashion server operative to peer-to-peer connect and enable the plurality of user communication devices and the plurality of seller communication devices to freely exchange past and current fashion and apparel (F&A) image files; wherein every time the past and current fashion and apparel (F&A) image files is exchanged, the AI based fashion server is operative to replicate the past and current fashion and apparel (F&A) image files, link, and codify the current fashion and apparel (F&A) image files with past fashion and apparel (F&A) image files so that the plurality of user communication devices have an open record of the past and current fashion and apparel (F&A) image files being exchanged; the AI based fashion server is operable to provide clothing fitness, fashion recommendation, store and discount recommendation, and fashion trend commendation to the plurality of user communication devices using deep learning algorithms performed on the open records of past and current fashion and apparel (F&A) image files.

Another object of the present invention is to provide a method and system for providing an all-in-one personal fashion coaching and assistance to users using deep learning network deliverable to a communication device of a user are disclosed, which includes: (a) providing clothing fitness services use after receiving input images and personal parameters from users; (b) providing try-on services using the body model and measurements and input images of F&A items; (c) providing smart style services by matching input images of F&A items extracted from past and current fashion and apparel (F&A) image files exchanged in a peer-to-peer manner among users and sellers; (d) providing a recommendation services to end-users by providing fashion trends, stores, locations, discounted prices, and special deals.

Another object of the present invention is to provide a software program stored in a non-transitory memory and executed by a processor to perform the following functions: (a) providing clothing fitness services use after receiving input images and personal parameters from users; (b) providing virtual try-on services using the body model and measurements and input images of F&A items; (c) providing smart style services by matching input images of F&A items extracted from past and current fashion and apparel (F&A) image files exchanged in a peer-to-peer manner among users and sellers; (d) providing a recommendation services to users by finding fashion trends, stores, locations, and suitable discounted prices.

Yet another object of the present invention is to combine artificial intelligence (AI) and end-users in peer-to-peer transmission and blockchain databases to provide a complete personal fashion coaching and assistance to users that includes the following services: (a) providing clothing fitness services use after receiving input images and personal parameters from users; (b) providing try-on services using the body model and measurements and input images of F&A items; (c) providing smart style services by matching input images of F&A items extracted from past and current fashion and apparel (F&A) image files exchanged in a peer-to-peer manner among users and sellers; (d) providing a recommendation services to users by finding fashion trends, stores, locations, and suitable discounted prices.

Yet another object of the present invention is to combine artificial intelligence (AI) and end-users in peer-to-peer transmission, and share mobile computing architecture to provide a complete personal fashion coaching and assistance to end-users that includes the following services: (a) providing clothing fitness services use after receiving input images and personal parameters from users; (b) providing try-on services using the body model and measurements and input images of F&A items; (c) providing smart style services by matching input images of F&A items extracted from past and current fashion and apparel (F&A) image files exchanged in a peer-to-peer manner among users and sellers; (d) providing a recommendation services to users by finding fashion trends, stores, locations, and suitable discounted prices.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 illustrates a method for providing an all-in-one personal fashion coaching and assistance that combines body measurement service, virtual try-on service, recommendation service, and e-shopping service using network connections and artificial intelligence (AI) algorithms in accordance with an exemplary embodiment of the present invention

FIG. 2 illustrates a method for body measurements and virtual try-on (clothes fitting) using convolutional neural network (CNN) algorithms in accordance with an exemplary embodiment of the present invention;

FIG. 3 is a schematic diagram of a personal fashion coaching and assistance system that includes artificial intelligence (AI) based service unit that includes a body measurement module, a virtual try-on module, a smart style module, and a recommendation module in accordance with an exemplary embodiment of the present invention;

FIG. 4 is a block diagram of the AI-implemented body measurement module that uses convolutional network (CNN) algorithms to generate a three-dimension body model of an end-user in accordance with an exemplary embodiment of the present invention;

FIG. 5A-FIG. 5B illustrate a map of local descriptors of 2D pivot sparse key-points on the body shape of a user in accordance with an exemplary embodiment of the present invention;

FIG. 6 is a block diagram of the fashion and apparel (F&A) mixing and matching function of different F&A items for the virtual try-on and recommendation modules of the personal fashion coaching and assistance system in accordance with an exemplary embodiment of the present invention;

FIG. 7 illustrates a diagrammatic representation of the virtual try-on module in accordance with an exemplary embodiment of the present invention;

FIG. 8 is a schematic diagram of the virtual try-on module and the body measurement module in accordance with an exemplary embodiment of the present invention;

FIG. 8 illustrates a high-level multiple virtual try-on module in accordance with an exemplary embodiment of the present invention;

FIG. 10 is a block diagram of the shoot-it-wear-it-buy-it module of a personal fashion coaching and assistance system in accordance with an exemplary embodiment of the present invention;

FIG. 11 shows a diagrammatic representation of a wardrobe sharing module of the web-based smart style system servicing end-users in a peer-to-peer and open source blockchain structure in accordance with an exemplary embodiment of the present invention;

FIG. 12 shows the front-end display of the body measurement module that uses the artificial intelligence (AI) service of personal fashion coaching and assistance system in accordance with an exemplary embodiment of the present invention;

FIG. 13 shows the front-end display of the virtual try-on module that uses the artificial intelligence (AI) service of personal fashion coaching and assistance system in accordance with an exemplary embodiment of the present invention;

FIG. 14 illustrates a front-end display of the style recommendation module that uses the artificial intelligence (AI) service of the personal fashion coaching and assistance system in accordance with an exemplary embodiment of the present invention;

FIG. 15 illustrates the front-end display of the style recommendation module that uses the artificial intelligence (AI) service of personal fashion coaching and assistance system in accordance with an exemplary embodiment of the present invention;

FIG. 16 illustrates the front-end display of the shoot-it-wear-it-buy-it module that uses the artificial intelligence (AI) service of personal fashion coaching and assistance system in accordance with an exemplary embodiment of the present invention;

FIG. 17 illustrates the shaking operation of a smart phone as part of the buy it module operative to find the nearest stores that sell the style of a user in accordance with an exemplary embodiment of the present invention;

FIG. 18 illustrates the wardrobe collection of the personal fashion coaching and assistance system in accordance with an exemplary embodiment of the present invention;

FIG. 19 illustrates the front-end webpage representation of the smart style module in accordance with an exemplary embodiment of the present invention;

FIG. 20 illustrates another front-end webpage representation of the personal fashion coaching and assistance system in accordance with an exemplary embodiment of the present invention; and

FIG. 21 illustrates a QR code of a fashion and apparel (F&A) created by the smart style module of the AI service in accordance with an exemplary embodiment of the present invention.

The figures depict various embodiments of the technology for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in details to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in details so as not to unnecessarily obscure aspects of the present invention.

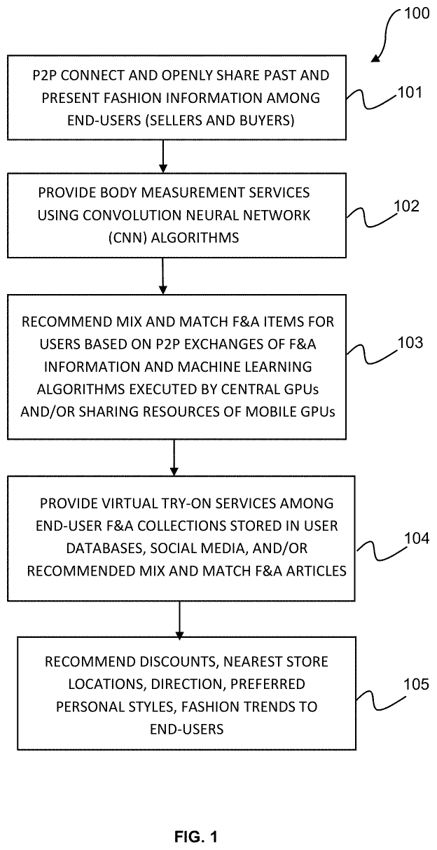

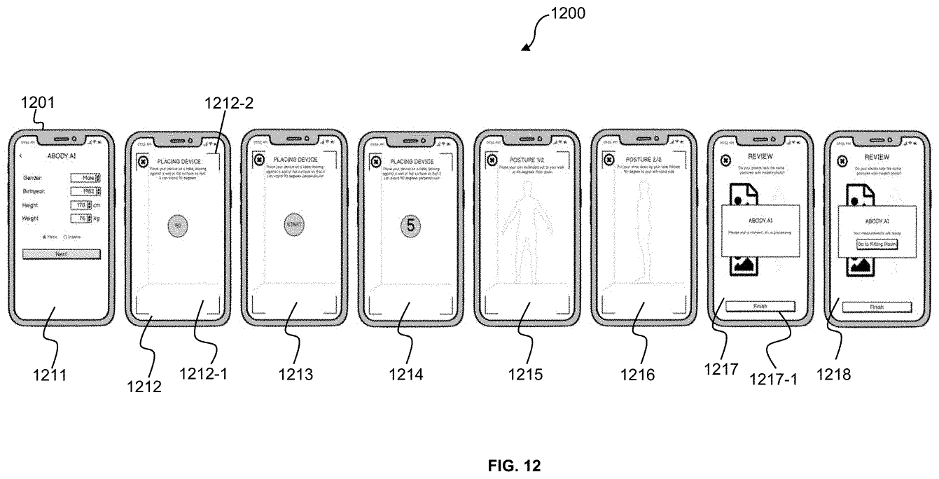

Exemplary embodiments and aspects of the present invention are now described with reference to FIGS. 1 to 21. The present disclosure discloses the following features: (1) a smart personal fashion coaching and assistance system using artificial intelligence (AI) that uses fashion and apparel (F&A) image files shared among buyers and sellers (end-users) to provide the following services to users: (a) body measurements to provide 3D body model and measurements; (b) clothes fitting services (virtual try-on), (c) mixing and matching of fashion and apparel (F&A) items that fit a user fashion style, (d) stores, locations, special deals, and discounts recommendations, and (d) fashion trends commendation; (2) a method and a computer software applications for personal fashion coaching and assistance system using artificial intelligence and fashion data transmitting peer-to-peer in an open network. FIG. 1-FIG. 11 illustrate backend hardware and/or software smart personal fashion coaching and assistance system. FIG. 12-FIG. 21 illustrate various frontend display pages of the personal fashion coaching and assistance system as the results of (1)-(2) on an exemplary communication device such as a smart phone.

Now referring to FIG. 1 which presents a flow chart of a method 100 for providing a personal fashion coaching and assistance using artificial intelligence (AI) deep learning algorithms that use fashion and apparel (F&A) image files openly shared among users and sellers in a peer-to-peer connectivity in accordance with an exemplary embodiment of the present invention. Method 100 includes a connecting and sharing service 101, a body measurement service 102, a recommendation of mix and match of different F&A items using shared fashion and apparel (F&A) image files 103, a virtual try-on (clothes fitting) service 104, and a store, location, discount, and fashion recommendation service 105. The combination of services 102-105 provided in a single communication device such as smart phone using shared fashion information via a peer-to-peer and open source network connections and artificial intelligence algorithms is the essence of the present invention.

It is noted that connecting and sharing of fashion and apparel (F&A) information via service 101 may include sharing fashion & apparel (F&A) image files using a peer-to-peer blockchain network to retrieve end-user images posted in a social media such as Facebook, Twitter, Zalo, WhatApp, Viber, Weibo, or the likes. As such, service 101 includes application programming interfaces (API) to enter these social media to retrieve the end-users past and present images and store them in either image databases or replicate databases for machine learning (ML) processing.

First, at step 101, end-users including retailers and buyers are connected together via a network and fashion and apparel (F&A) image files are shared among them. In many aspects of the present invention, the network includes, but not limited to, Zigbee, Bluetooth, Wi-Fi, Z-wave, local area network (LAN), wide area network (WAN), internet, cloud, peer-to-peer and open source blockchain network. Fashion and apparel (F&A) image files including images, videos either stored in the shared databases or extracted from social media such as Facebook, Twitter, Zalo, Viber, WhatApps, Weibo, or the likes. In the implementation of step 101, an application programming interface (API) enters the shared databases and/or social media of end-users and extracts F&A image files therefrom. These fashion and apparel (F&A) image files are stored in either image databases and/or replicate databases so that each end-user can have access to the fashion collection of other end-users including retailers. In various aspects of the present invention, the past and present fashion and apparel (F&A) information of end-users including retailers are openly shared and linked together into an open ledger analogous to the blockchain mechanism so that every end-users including retailers can have records of past and present fashion and apparel (F&A) image files of all other end-users including retailers (sellers).

At step 102, a body measurement service is provided by using the fashion and apparel (F&A) image files obtained in step 101 processed by different convolutional neural network (CNN) algorithms. Step 102 can also be divided into different modules. First, a body frame of a user is extracted from either photo images or videos. Second, end-user parameters including tailor measurements of height, weight, age, neck size, chest size, arm length, waist, legs, buttstock, etc. are obtained. Third, using a CNN algorithm, dense keypoints are placed on the extracted body frame of the end-user. Dense keypoints are placed to describe the features of each body part of the user. Dense keypoints can be derived from picture pixels of a photo or video image of an end-user. Dense keypoints depict the feature of each user. For example, looking into dense keypoints of end-user A and user B, viewers can recognize both of them. Each dense keypoint includes a locator and a discriminative descriptor. Thus, dense keypoints of end-user A will be different from those of end-user B. Fourth, sparse keypoints are obtained from dense keypoints to describe the border or skeleton of an end-user. For example, sparse keypoints describe the outline shape of an end-user. As a further example, either the end-user is athletic, chubby, or skinny, short or tall, etc. Fifth, two-dimension (2D) pivot keypoints are obtained from the personal parameters, dense keypoints, sparse keypoints to describe local features of each body part. For example, if the waist line of an end-user is particularly big, 2D pivot keypoints will show this feature. Finally, three-dimension (3D) pivot keypoints are derived to reconstruct a 3D body model (3D reconstruction) and measurements of an end-user. The body model and measurements are obtained from a convolutional neural network (CNN) algorithm such as histogram of local gradients known as SIFT. Other algorithms that can provide both repeatable and reliable local descriptors are also used in step 102.

At step 103, mix and match F&A items are recommended to end-users using network connection, machine learning algorithms, and shared databases. As the result of step 103, the fashion collection of end-users and sellers (retailers) are openly shared by peer-to-peer (P2P) blockchain network. Every past and present fashion collection of an end-user is copied in replicate databases, linked (chained), codified, and shared among end-users in a peer-to-peer manner. In the implementation of step 103, websites or software modules called smart style module configured to learn a particular end-user style, go through the shared fashion collections of other end-users to pick out mix and match F&A items, and present them to end-users.

At step 104, a virtual try-on service (clothes fitting) is provided with inputs from photos, videos, recommended clothes from sellers and/or other end-users, clothes picked out from social media such as Facebook, Twitter, Viber, Zalo, WhatApp, mix and match F&A items from step 103. The virtual try-on service also includes fitting modules similar to body measurements service but applicable to fashion and apparel (F&A) items, not on end-users. First, F&A items worn by an end-user are extracted from either photos or videos. Second, end-user parameters including tailor measurements of height, weight, age, neck size, chest size, arm length, waist, legs, buttstock, etc. are obtained. Third, using a CNN algorithm, dense keypoints are placed on those extracted F&A items, e.g., clothing units. Dense keypoints are placed to describe feature of each clothing units. Dense keypoints can be derived from picture pixels of a photo or video image of the clothing units. Dense keypoints depict the feature of each clothing unit. Each dense keypoint includes a locator and a discriminative descriptor. Thus, dense keypoints of a pant will be different from those of a shirt. Fourth, sparse keypoints are obtained from dense keypoints to describe the border or outline of a clothing unit. For example, sparse keypoints describe the outlined shape of a skirt. Either this is a dress, a short skirt, or a long skirt. Fifth, three-dimension (3D) pivot keypoints are derived to reconstruct a 3D body model (3D reconstruction) and measurements of each clothing unit. The 3D reconstructions of the F&A items are obtained from a convolutional neural network algorithm such as histogram of local gradients known as SIFT. Other algorithms that can provide both repeatable and reliable local descriptors are also used in step 104. Finally, a mapping unit is used to map the 3D reconstruction model of a clothing item onto the 3D body model and measurements of an end-user. In some aspects of the present invention, F&A items that fit and match personal style of an end-user will be provided with a codes such as QR code, bar codes, etc. so that when the end-users decide to buy these F&A items, they only need to scan or to press on these codes, store locations, discounted programs, and/or fashion collection of other end-users are recommended and displayed on the communication devices. It is noted that communication devices in the present disclosure include, but not limited to, smart phones, tablets, desktop computers, laptop computers, personal digital assistant (PDA), smart cameras, virtual reality (VR) device, augmented reality (AR) devices, or the likes.

At step 105, retailers, locations, directions thereof, discounted programs, special deals, and fashion trends are recommended to end-users. Step 105 is implemented using machine learning network and shared personal fashion collections on the peer-to-peer and open source network. More particularly, step 105 includes API that go through end-users' databases, social media such as Facebook, Twitter, Viber, Zalo, and WhatApps, Weibo, or the likes to search for F&A items that either fit or possibly fit the fashion style of a particular end-user. In some other aspects of the present invention, chatbots can be used to recommend fashion trend and F&A items to end-users. In various aspects of the present invention, step 105 also includes fashion trend surveys using machine learning and recommendation of upcoming fashion trends to end-users.

Within the scope of the present disclosure, a peer-to-peer manner and peer-to-peer network are defined the “peers” or end-users are communication devices which are connected to each other via a network such as the Internet. Fashion data can be shared directly between communication devices on the network without the need of a central server. In other words, each communication device on a P2P network becomes a file server as well as a client. The only requirements for communication devices to join a peer-to-peer network are an Internet connection and P2P software. Common P2P software programs include Kazaa, Limewire, BearShare, Morpheus, and Acquisition. These programs connect to a P2P network, such as “Gnutella,” which allows the communication devices to access thousands of other systems on the network. Once connected to the network, P2P software allows a particular communication device to search for fashion data on other communication devices. Meanwhile, other communication devices on the network can search for files on a particular communication device, but typically only within the replicate databases that a particular end-user 311 has designated to share.

Within the scope of the present disclosure, communication device includes, but not limited to, smart phones, laptops, desktop computers, smart cameras, tablets, and personal digital assistant (PDA), virtual reality (VR) devices, augmented reality (AR) devices, smart eyeglasses, etc.

In addition, within the scope of the present disclosure, method 100 is realized by either central graphic processing units (GPUs) and/or sharing GPU resources in a cluster mobile computing infrastructure among the communication devices of end-users 311 connected via a cloud-based network.

From the detailed disclosure of method 100 above, the following objects of the present invention are achieved: (1) a complete personal fashion coaching and assistance disposed at communication devices are available at any time on the end-user communication devices; (2) searching for fashion and style that are best fit to end-users reduces transaction time and searching costs; (3) clothes fitting is guaranteed; (4) unfitted clothes and inappropriate fashion are substantially reduced, saving time and money and efficiency; (5) personal fashion collection is shared among end-users and sellers in the peer-to-peer and open source manner so that new fashion, discounts, and clothes availabilities can readily be acquired on the communication devices with a few touches without wasting search time and money, avoiding inappropriate, out of fashion, out of occasion, and unfitted fashion and apparel.

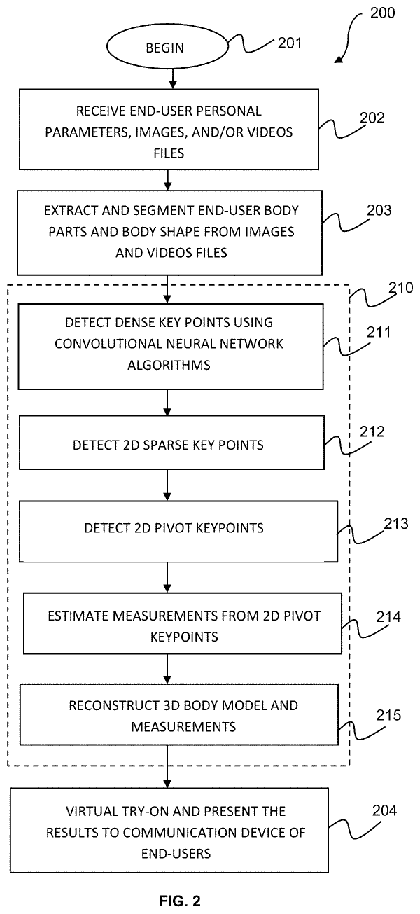

Next, referring to FIG. 2, a method 200 of clothes fitting or virtual try-on for end-users that uses shared personal fashion collection in a peer-to-peer and open source network and artificial intelligence such as convolutional neural network (CNN) algorithms in accordance with an exemplary embodiment of the present invention is disclosed.

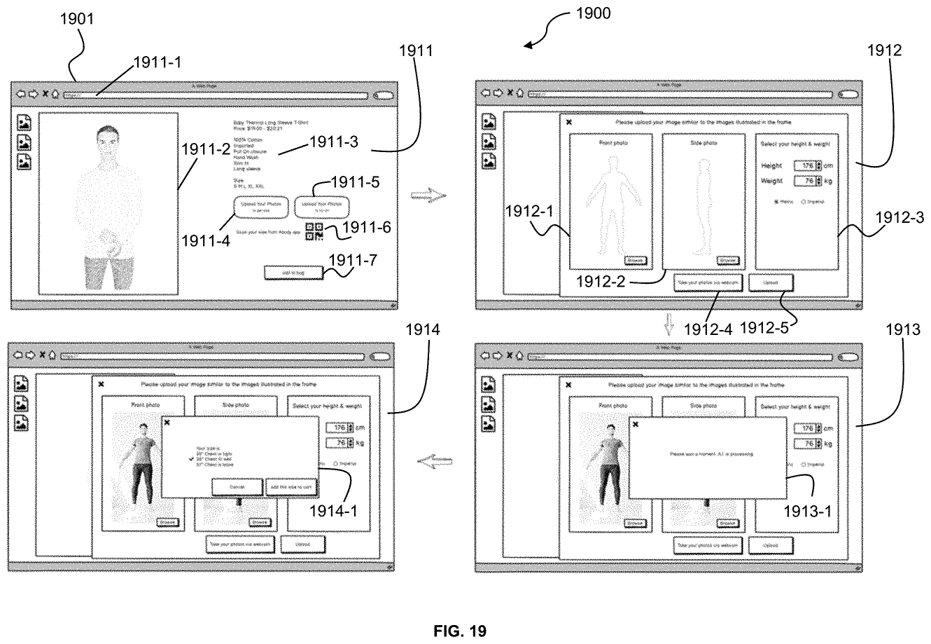

At step 201, method 200 begins by (a) authenticating end-users into a website (see FIG. 19 to FIG. 21) or a software app (see FIG. 12 to FIG. 18), (b) starting a software application such as API by clicking on an icon on end-user communication devices, and (c) receiving end-users input pictures or videos from either end-user databases, recommended F&A, e.g., clothing units, other end-user databases in the peer-to-peer network, and/or from a social media such as Facebook, Twitter, Zalo, Viber, WhatApps, Weibo, or the likes. In some aspects of the present invention, step 201 is implemented by an API that enters into a social media collecting and saving all pictures and videos of end-users into at least one image databases, replicate databases, or blockchain databases.

At step 202, F&A, e.g., clothing units that an end-user would like to try-on are received. Step 202 is implemented by the end-user pressing on a “try-on” or “clothes fitting” icon or button on the software application and/or a website as described in FIG. 1. Please refer to FIG. 12 to FIG. 21 for further explanation of step 202.

At step 203, once images or videos files of an end-user are received, the body of end-users are recognized and extracted from the background and other people in the images or videos. Step 202 is implemented by a computer vision algorithm and a facial recognition program. The facial recognition program allows step 203 to select the correct end-user among other peoples in the pictures or videos.

Finally, at step 204, the F&A items are mapped on the most current body model of the end-user to see if these F&A items fit the end-user. In some aspects of the present invention, after successful try-ons and the end-users like the tried-on F&A items, codes such as QR codes are assigned. Next, steps 211-214 are used to adjust the reconstruction and measurements of the F&A items so that they fit the end-users. Retailers or sellers can based on the adjustments to alter the F&A items for that particular end-user.

Now service process 210 including steps 211-214 are common to both body measurements and reconstruction of F&A items. The objective of service process 210 is to create a 3D model and measurements for both end-users and the F&A items they want to try on.

At step 211, dense keypoints of the end-user are detected. Step 211 is implemented using convolutional neural networks (CNN) algorithms, a deep learning approach, that uses trained pictures to learn about end-user featurized keypoints and local descriptors. Upon receiving of new images, these CNN algorithms create and compare histograms of dense keypoints. The objective is to achieve repeatability and reliability confidence maps. The two maps are in fact estimates of the probabilities that a keypoint is respectively repeatable and that its descriptor is discriminative, i.e., it can be accurately matched with high confidence. Dense keypoints correspond to locations that maximize both confidence maps. To train the keypoint detector, step 211 employs unsupervised loss that encourages repeatability, sparsity as well as a uniform coverage of the image. In some aspects of the present invention, the local descriptor is trained with a listwise ranking loss, leveraging recent advances in metric learning based on an approximated Average Precision (AP) metric, instead of using a standard triplet or contrastive loss. Again, the objective of step 211 is to achieve a reliability confidence value to predict which pixels will have descriptors with a high AP, i.e., that are both discriminative, robust and in the end that can be accurately matched.

Next, at step 212, sparse keypoints are generated based on dense keypoints. If the dense keypoints which are based on image pixels include local descriptors to depict features of end-users, sparse keypoints reduce number of keypoints to outline the shape and key features of end-users and/or F&A items. The purposes again are to achieve repeatability, descriptive, and processing time because unnecessary keypoints are eliminated to save processing and database real-estate.

At step 213, two-dimension (2D) pivot keypoints are detected. 2D pivot keypoints focus on special features on an end-user such as waistline circumference, buttstock, etc. Step 213 can be implemented by detecting the local descriptors and local maxima of dense and sparse keypoints.

At step 214, three-dimension (3D) body model and garment models with measurements that tailors can make these F&A items for the end-user are generated based on personal parameters, dense keypoints, sparse keypoints, 2D pivot keypoints. Personal parameters include height, weight, age, sex, and tailor measurements of each end-user. Based on these and apparel (F&A) image files, the CNN algorithms reconstruct the 3D models and measurements for F&A items and/or end-users.

It is noted that method 200 is realized by either central graphic processing units (GPUs) and/or sharing GPU resources in a cluster mobile computing infrastructure among the communication devices of end-users 311 connected via a cloud-based network.

Method 200 of the present invention achieves the following objects: (1) body model and measurements; (2) virtual try-on (clothes fitting) that are convenient because end-users can try on any F&A items at any time without wasting time waiting in line in the fitting rooms; (3) searching time and costs looking for F&A items that are suitable in occasion, fitting, and style are reduced significantly; (4) as the results of (1)-(3), end-users including retailers, sellers, and buyers can sell and exchange F&A items that suit end-users in terms of style and fitting.

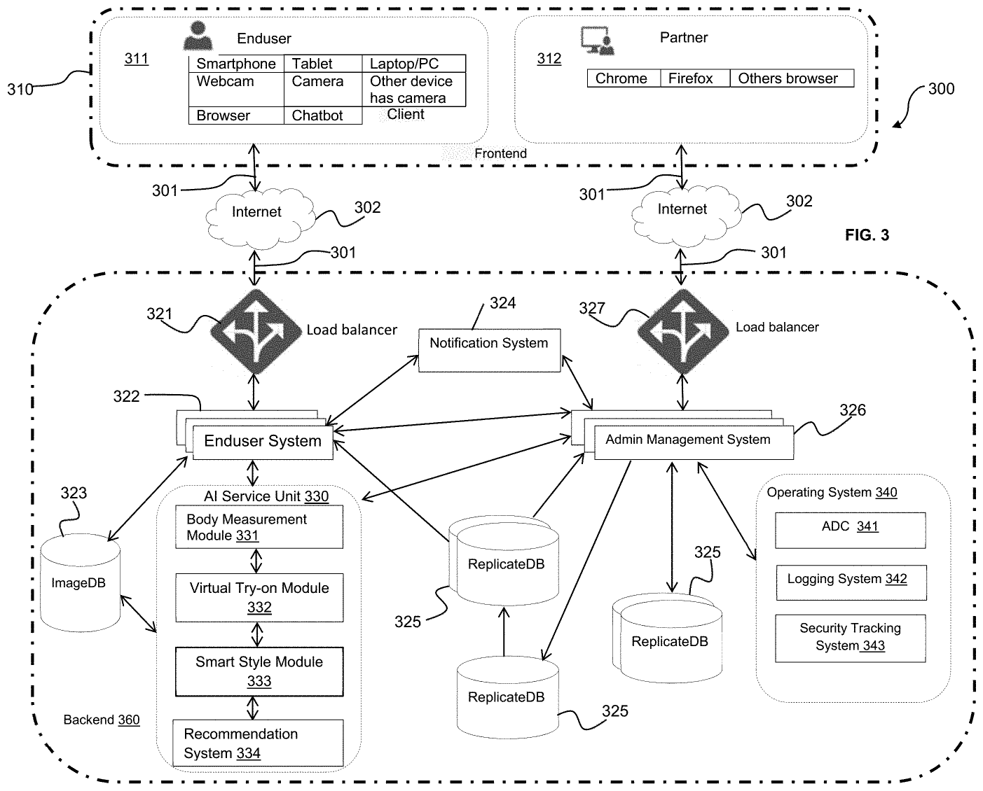

Next referring to FIG. 3, a schematic diagram of a personal fashion coaching and assistance system 300 (“system 300”) that implements method 100 and 200 above in accordance with an exemplary embodiment of the present invention is disclosed. At the heart of system 300, an artificial intelligence (AI) based service module 330 includes a body measurement module 331 designed to implement steps 211-214, a try-on module 332 designed to implement steps 201-214 of method 200, a smart style module 333 designed to implement steps 103-105, and a recommendation module 334 designed to implement steps 103-105.

System 300 includes a front-end system 310 and a backend system 360. Front-end system includes end-users 311 which further include end-users, sellers, retailers who use communication devices such as smart phones, tablets, cameras, laptops, personal computers (PC), web-cams, virtual reality (VR) devices, augmented reality (AR) devices, or any devices that have cameras and memories that are equipped with system 300 and embedded with methods 100 and 200. Front-end system 310 also includes a third party 312 such as ABODY™ company who manages a web-site, a social media, or a software application programming interface (API) that performs method 100 and method 200 above. End-users 311 can access to system 300 to use the services provided by methods 100 and 200 by executing a software application such as an application programming interface (API) on their communication devices. Alternatively, the access to system 300 to use the services of methods 100 and 200 can be achieved by entering a website delivered by Chrome, Firefox, Internet Explorer (IE), Google, or other browsers. It is also noted that the term “end-user” refer to the users who are benefited from system 300 embedded with methods 100-200 and different from the developers, installers, administrators, operators, and service providers 312. The “end” part of the term derives from the fact that most information technologies involve a chain of interconnected communication devices at the end of which is the “end-user.” Frequently, end-user 311 include users, buyers, sellers, and retailers who use communication devices such as smartphones, tablets, laptops, personal computers (PC), webcams, smart cameras, and any smart devices that have cameras.

Continuing with FIG. 3, front-end system 310 is connected to back-end system 360 via a network 302 and communication links 301. Within the scope of the present invention, network 302 includes internet, cloud network, wide area network (WAN), metropolitan area network (MAN), local area network (LAN), personal area network (PAN) connected in the peer-to-peer configuration. That is, on one hand, system 300 can connect a small group of end-users 311 including buyers, F&A retailers, and a third party provider in a PAN using NFC, Bluetooth, Wi-Fi, Zig-bee, Z-wave, wireless USB, ANT UWB. On the other hand, system 300 can connect a large group of end-users, F&A retailers, and third party provider from around the world via the internet, WAN, MAN, LAN, and cloud. Communication links 301 may include LAN based wired connections or wireless connections. Wired connections include coaxial cables, fiber optic cables, and RS-32 cables, etc. Wireless connections of communication links 301 may use IEEE 802.11 standards, fiber optics, radio frequencies (RF), Bluetooth, Z-wave, Zigbee, Wi-Fi signals.

Referring again to FIG. 3, backend system 360 includes an input load balancer 321, an end-user system 322, an image databases 323, a notification system 324, replicate databases 325, an administrative management system 326, AI service module 330, an operating system (OS) 340, and an output load balancer 327. More specifically, input load balancer 321 and output load balancer 327 sit between backend system 360 and front-end system 310, defined as the methodical and efficient distribution of network or application traffics across above-listed modules in system 300, configured to receive and then distribute incoming requests to any available modules capable of fulfilling them. Input load balancer 321 and output load balancer 327 include physical devices, virtualized instances running on specialized hardware or a software processes (e.g., method 100, method 200, operating and other service software programs, etc.) that are incorporated into application delivery controllers (ADCs) 341 designed to more broadly improve the performance and security of three-tier web and micro services-based applications, regardless of where they're hosted. Input load balancer 321 and output load balancer 327 are also able to leverage many possible load balancing algorithms, including round robin, server response time and the least connection methods to distribute traffic in line with current requirements.

Continuing with FIG. 3, end-user system 322 includes a registration and authentication of end-users 311. It is noted that registration and authentication can be either hardware token and/or software token. Hardware registration and authentication tokens are an authenticator in the form of physical objects such as smart cards, USB, PIN tokens. The interactions of end-users 311 with end-user system 322 prove that end-users 311 physically possess the hardware tokens. Proving possession of the tokens may involve one of several techniques: (a) Reading a periodically changing pseudo-random number from the Token's display and typing it into a login prompt; (b) keying a challenge string displayed by the login system into the Token, and typing a string that the Token displays as a result back into the login system; (c) plugging the Token into the workstation, using a USB port, or some other connection (parallel or serial port, smart card slot, etc.). Hardware tokens authenticate end-users 311 on the basis that only the token assigned to end-users 311 could have generated the pseudo-random number or code response keyed in by end-users 311. Successful entry of this code implies that end-users 311 are in physical possession of the tokens. Hardware authenticators of end-user system 322 also include RFID cards, QR codes, biometric characters, and barcodes readers, or the likes.

Software authenticators are application programming interfaces (API) such as webADM, Google Cloud Platform (GCP) API, etc. Username, PKI, and/or password that allows access to use system 300 and methods 100 and 200 are required. PKI Public key infrastructure (PKI) is a universal security fundamental facility, it can fulfil and supply security service by using public key algorithm principle and technology. One of its core services is identify authentication. The components of PKI are security strategy, certificate authority (CA), registration authority (RA), certificate management system, hardware and software system, and PKI application interface, etc. Certificate authority is an authority which issues the certificate according to the certificate management strictly. Due to the security requirements, CA extends the online checkup subsystem for end-user registration as the end-user interface that is the Registration Authority (RA). The functional responsibility of certificate management system is mainly consisting of creation and issuance digital certificate, receiving and handling the certificate update request of end-users 311, receiving and handling the certificate withdrawal request and create and issuing a withdrawal list, receiving and handling the certificate and CRL inquire request, and so on. In the usage of identity authentication based on PKI, end-users 311 firstly apply the own personal digital certificate and then log in the website to identify authenticate it with the certificate. In various embodiments of the present invention, end-user system 322 also receive and manage the input images, chats, searches, and requests from end-users 311. After being serviced by AI service module 330 that performs methods 100 and 200, end-user system 322 sends the outputs and/or results to notification system 324 and administrative management system 326 to end-users 311.

Continuing with FIG. 3, image databases 323 are non-transitory storages that store fashion and apparel (F&A) images which can be personal fashion collection of end-users 311 including buyers and/or sellers/retailers. In some aspects of the present invention, image databases 323 are also configured to store fashion and apparel collections from social media such as Facebook, WhatsApp, Instagram, Viber, Twitter, Zalo, Weibo, or the likes. Replicate databases 325 are designed to store copies of fashion collection between buyers and sellers/retailers. In many aspects of the present invention, replicate databases 325 are used to store codified past and present records of fashion collections among end-users 311. These past and present records of fashion collections are linked together and encoded so that they are open, viewed, and used by end-users 311. Images databases 323 and replicate databases 325 are non-volatile semiconductor memories such as ROM, PROM, EPORM, EEPROM, flash memories, etc. Other types of data storages include magnetic devices such as floppy discs, ZIP drives; optical devices such as compact discs (CD), Digital Video Discs (DVD), Blue Rays, etc.

Still referring to FIG. 3, notification system 324 is a combination of software and hardware that provide means of delivering a message to end-users 311, which includes e-mail, SMS text messages, drawer notification in the status bar, head-ups, lock-screens, graphic user interface (GUI) or icons. Notification system 324 sends notifications to end-users 311 after completing a request such as search for new clothes, body measurements, new fashion, stores nearby that have discounts and available particular F&A items as described in method 100 and method 200. Next, administrative management system (AMS) 326 is hardware and software modules that generate and manage all application programming interfaces (API) for system 300. The AMS APIs include those for end-user system 322, AI service module 330, notification system 325, replicate databases 325 as alluded above.

The artificial intelligence (AI) base of system 300 is AI service module 330 that includes body measurement module 331, virtual try-on module 332, smart style module 333, and recommendation module 334. More specifically, body measurement module 331 implements step 200 described above, which provides 3D body models (reconstruction) and measurements for each of end-users 311 and F&A items. In various embodiments of the present invention, body measurement module 331 consists of a convolutional neural network (CNN) as an encoder and a fully connected neural network (FCNN) as a regression unit. It is noted that AI service module 300 includes either central graphic processing units (GPUs) and/or sharing GPU resources in a cluster mobile computing infrastructure among the communication devices of end-users 311 connected via cloud-based network 302.

Virtual try-on module 332 allows end-users 311 to view on their communication devices how particular F&A items fit them without having to physically try the F&A items on. Smart style module 333 amasses image records of fashion and apparel (F&A) collections from end-users 311 and social media stored in replicate databases 325. Then, smart style module 333 use machine learning algorithms to send the F&A items that fashionably suit a particular end-user 311. End-users 311 use body measurement module 331 and virtual try-on module 332 to see if these recommended F&A items fit well. Recommendation module 334 searches for stores and retailers that have the F&A items that end-users 311 select, try-on, and decide to buy. In summary, AI service module 330 provides the following cumulative services to end-users 311 that the fashion & apparel (F&A) market longs for: (1) How does F&A items fit a particular end-user 311; (2) How do clothing item look on particular end-users 311; (3) what should end-users wear in a specific social event; (4) Are there any discounted F&A items that fashionably and physically fit end-users 311; (4) are there any stores/retailers nearby that have F&A items that fashionably and physically fit end-users 311.

Referring again to FIG. 3, similar to input load balancer 321, output load balancer 327 sits between backend system 360 and front-end system 310, defined as the methodical and efficient distribution of network or applications traffics across above-listed modules in system 300, configured to receive and then distribute outgoing outputs to end-users 311. Operating system (OS) 340 is a software which performs all the basic tasks that support AI service module 330. These basic tasks include input load balancer 321, image databases 323, end-user system 322, notification system 324, AMS 326, output load balancer 327 management, replicate databases 325 management, method 100 and method 200 coordination, handling input and output, and controlling peripheral devices such as display devices, printers, etc. Operating system 340 includes application delivery controller (ADC) 341, logging system 342, and security tracking system 343. ADC 341 assists input load balancer 321 and output load balancer 327 to efficiently handle the incoming and outgoing network traffics and operations. Logging system 342 watches over the registration and authentication processes of end-user system 322. Finally, security tracking system 343 tracks, links, and securitizes the exchanges of past and present fashion and apparel (F&A) collections between end-users 311. Consequently, each end-user among end-users 311 can have a codified past and present fashion collections that have time stamps and linked together: every exchange between end-users 311 is openly shared and recorded in replicate databases 325.

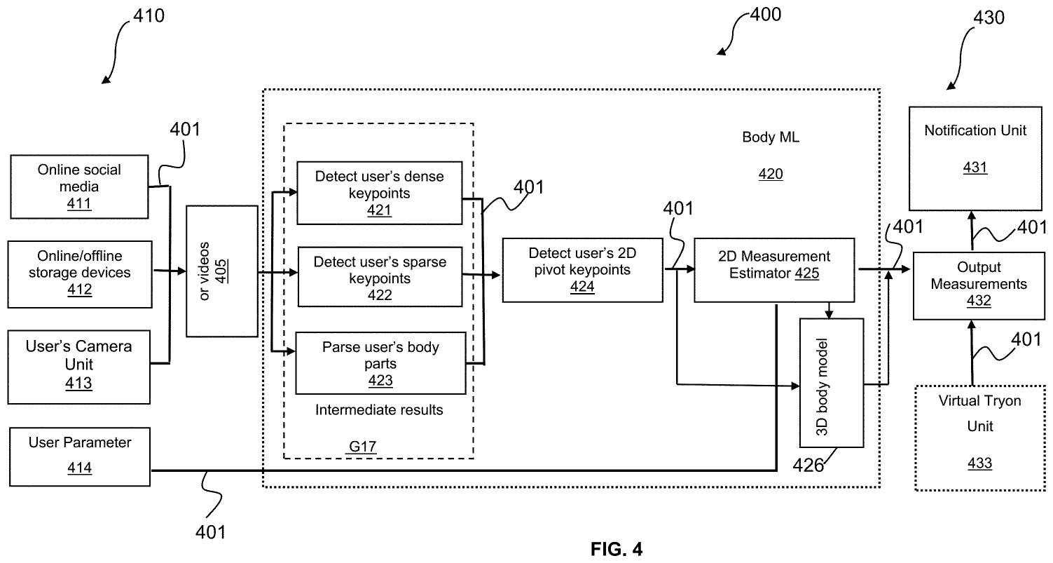

Next referring to FIG. 4 which is a block diagram of the AI-implemented body measurement module 400 that uses convolutional network (CNN) algorithms to generate a three-dimension body model and measurements of end-users 311 in accordance with an exemplary embodiment of the present invention. Body measurement module 400 is the same as body measurement module 331 discussed in FIG. 3 which includes an input section 410, a body machine learning section 420, and an output section 430. Input section 410 receives input images and videos from end-users 311 via different means. Such means include an online social media 411, an online/offline storage devices 412, a user camera(s) 413, user parameters 414, user images or videos 415. As mentioned earlier, social media 411 includes Facebook, Instagrams, Twitter, Zalo, Viber, Weibo, etc. That is, system 300 sends a retrieval API to retrieve images and videos of end-users 311 and F&A items from the listed social media and stores in either image databases and/or replicate databases 325. In various embodiments of the present invention, input section 410 and output section 430 include smart phones, laptops, desktop computers, smart cameras, webcams, augmented reality (AR) devices, virtual reality (VR) devices, flat screen displays, etc. Online/offline storage devices 412 can be either network databases, a cloud-based storage, and local memories on the communication devices of end-users 311. User camera 413 can be cameras integral to communication devices such as smart phones, augmented reality (AR) devices, and virtual reality (VR) devices. User parameters 414 include height, weight, all tailor measurements necessary to make perfect clothes fitting for a user. User parameters 414 can be entered via a software interface that asks for these measurements. User images or videos 415 poses of a user that are selected from photos and videos. In case of videos, body machine learning section 420 can identify and remove a particular end-user 311 from a group of people using localization and bounding box algorithms.

Continuing with FIG. 4, body measurement machine learning (ML) module 420 includes a dense keypoints detector 411, a sparse keypoint detector 412, a user body segmentation detector 423, a 2D pivot keypoint detector 424, a 2D measurement estimator 425, and a 3D body model detector 426. In principal, body measurement machine learning (ML) module 420 recognizes an end-user 311 or a piece of F&A item in an image from a set of learning images. Upon receipt of images or videos from input section 410, body measurement machine learning (ML) module 420 performs the following regression algorithm: (1) scan the image from left to right and bottom up; (2) classify different objects within the image using a body part parsing unit 423; (3) detect coarse features such as edge, shape, texture, colors based on the pixels of the image using a dense keypoint detector 421; (3) generate sparse keypoints (features) based on using a sparse keypoint detector 422; (4) detect pivot keypoints of end-users 311 using 2D pivot keypoint detector 424 that performs either regression algorithms or concatenated heat map layers. The sparse keypoints, dense keypoints, and body part segmentations are called intermediate results 427. Afterwards, body measurement machine learning module 420 finishes up the regression algorithms by: (5) estimate tailor measurements from 2D pivot keypoints; and (6) reconstruct the 3D body model of end-user 311 based on 2D pivot keypoints and user's parameters. In some various embodiments of the present invention, keypoints are determined by the localizations of the joints of end-users 311 in 2D RGB maps. Joints include knees, wrists, shoulder joints, etc. Thus, the tailor measurements can be estimated directly from 2D pivot keypoints without relying on the body 3D model. Heat maps layers are obtained from layers of RGB maps and concatenated into 2D pivot keypoints. Thus, coordinates (x,y) of keypoints or joints can be determined from 2D heat maps. In some embodiments, the 3D body model is reconstructed from 2D pivot keypoints. 3D body model is beneficial to virtual try-on step 104 because end-users 311 can rotate 360° and/scale the 3D body model to have better and complete views of how a particular F&A item fit.

Continuing with FIG. 4, output section 430 includes virtual try-on module 433 which is the same as virtual try-on module 332 in FIG. 3, a body model and measurements memory 432, and a notification unit 431 which sends a notification to notification system 324, and administrative management system (AMS) 326. Body model and measurements memory 432 is a cache memory that temporarily stores the current 3D body model and measurements. The next time, when the new 3D body model and measurements are performed, the cache memory is erased and replaced. Body model and measurements memory 432 can be DRAM, EEPROM, etc.

Notification unit 431 sends a message to administrative management system (AMS) 326 that the 3D body model and measurements are complete and ready. AMS 326 sends the results to end-users 311 via output load balancer 327. Output section 430 can be the displays of smart phones, laptops, desktops, tablets, smart cameras, PDA, augmented reality (AR), virtual reality (VR), and wearable devices. Communication links 401 that are connected all above items are either electrical connections, wireless connections, and/or flow directions of software subroutines.

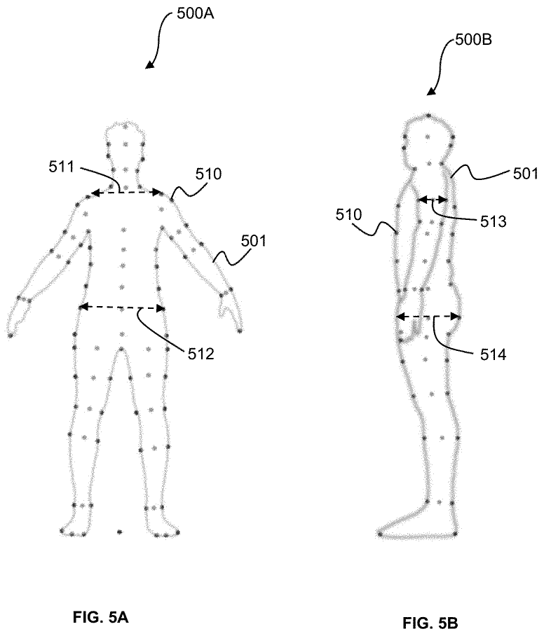

Next referring to FIG. 5A—FIG. 5B which illustrate maps 500A-500B of 2D sparse pivot keypoints on the body shape of a user in accordance with an exemplary embodiment of the present invention. FIG. 5A shows a front side 500A of a body shape 501 and sparse pivot keypoints 510 which outline not only the body shape but also special features (local descriptors or joints) of an end-user 311. This is an implementation of step 212 and step 213. FIG. 5B illustrates a lateral side 500B of body shape 501 and sparse pivot keypoints 510 which outline not only the side body shape but also special features (local descriptors) of an end-user 311. The exact tailor measurements can be obtained by the distance between the coordinates (x,y) of sparse pivot keypoints 510. Together, front side 500A and lateral side 500B, the 3D body model and measurements can be reconstructed with the assistance of user parameters. In some embodiments of the present invention, sparse pivot keypoints 510 are obtained from 2D pivot heat maps which are a set of concatenated gray images having the same dimension with RGB (red, green, blue) frames derived from the image files input by end-users 311. Each 2D pivot heat map has the highest value at the coordinate of the corresponding pivot. Each heat map corresponds to sparse pivot keypoint 510. All 2D pivot heat maps are then concatenated to form a heat map set for one view. If there are N views or N RGB frames, then N 2D pivot heat map set are generated. All 2D pivot heat map set with all RGB frames form the inputs to body measurement module 331. In either method, a shoulder measurement 511, a waistline measurement 512, an arm circumference 513, a buttstock measurement 514, etc. can be obtained from sparse 2D pivot keypoint 510.

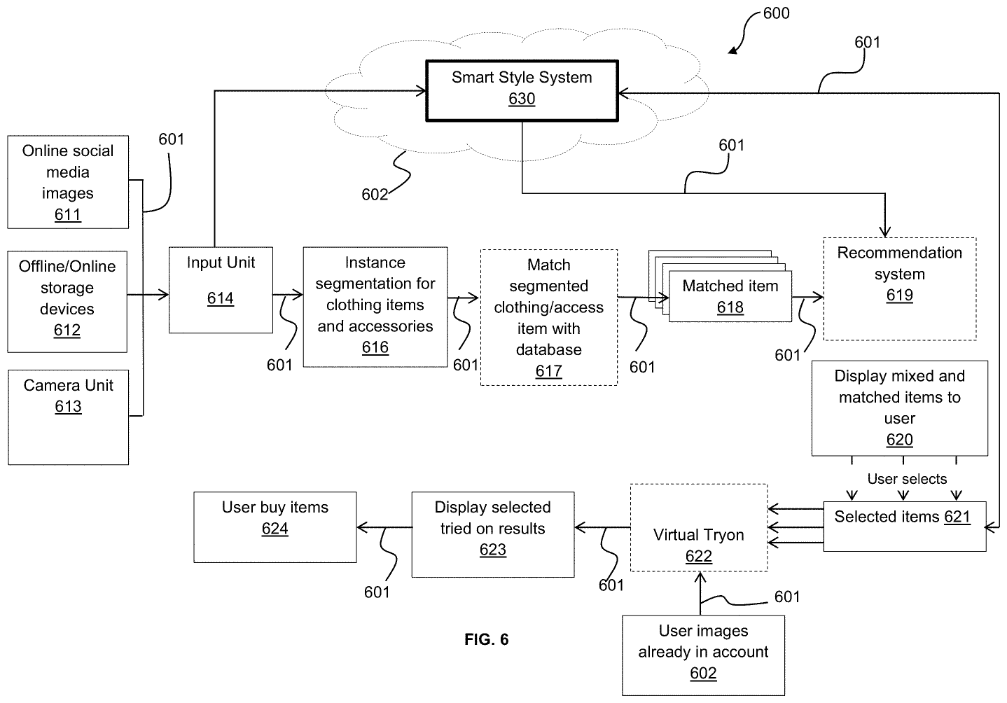

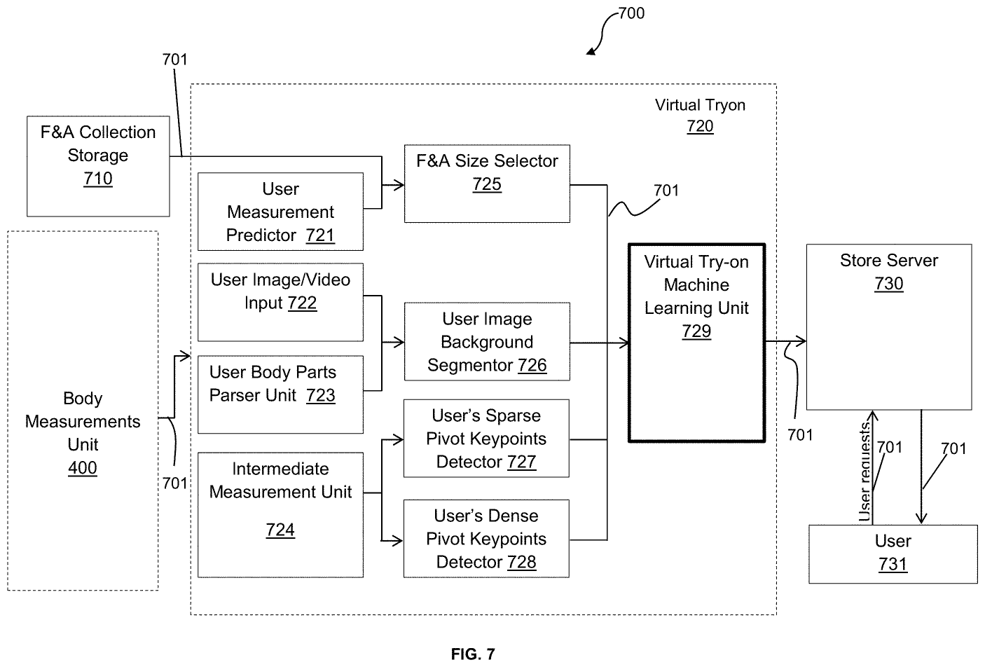

Now referring to FIG. 6, a block diagram of F&A items mixing and matching recommendation module 600 (mix and match module 600) in accordance with an exemplary embodiment of the present invention is illustrated. Mix and match module 600 is configured to learn from a personal fashion collection of end-users 311, search for different F&A items from other personal fashion collections to find those that fit with the target personal fashion collection, and present these mix and match F&A items to a particular user among end-users 311. In many embodiments of the present invention, mix and match module 600 includes online social media images 611, an online/offline storage devices 612, a camera units 613, a videos loading unit 614, a fashion and apparel (F&A) segmentation unit 616, a machine learning (ML) selector unit 617, a mix and match cache memory 618, a recommendation module 619, a display and notification module 620, a user selection unit 621, a virtual try-on module 622, a try-on display unit 623, and an e-commerce unit 624. Mix and match module 600 selects an assortment of F&A items uploaded by input unit 614 from different locations such as online social media unit 611, online/offline storage unit 612, and camera unit 613. These F&A items are separated by segmentation unit 616 to distinguish different units, e.g., pants, shirts, skirts, etc. Matching unit or comparator unit 617 compares and learns the different clothing units with personal fashion collection learning dataset stored in replicate databases 325 or image databases 323 to those that fit with a particular end-users 311. The results that fashionably match a personal fashion collection is stored in mix and match cache memory 618. Recommendation module 619 also receives inputs from smart style module 630 and displays them using display module 620. All of the F&A items are sent to end-users 311 to select which items they like to try on by selector unit 621 which can be a touchscreen icon, graphic user interface (GUI), a drop-down menu, a cursor, or a pointer. The selected mix and match F&A items are then tried on by virtual try-on module 623 that uses the 3D body model and measurements from body measurement module 400 discussed in FIG. 4. The detailed structure of virtual try-on module 623 will be discussed in the following FIG. 7. In various aspects of the present invention, end-users 311 can choose mix and match F&A items from different sources—from smart style module 630, from mix and match sources 611-614, and from personal fashion collection 602. After the clothes fitting, the results are displayed on the display unit 623. Finally, after having viewed the try-on results, end-users 311 can select to buy those F&A items that are physically and fashionably fit by either clicking on a graphic user interface (GUI) button, icon, and/or going through an e-commerce process. Communication links 601 that are connected all above items are either electrical connections, wireless connections, and/or flow directions of software subroutines. Smart style module 630 is a website uploaded in cloud-based network 603.

Mix and match system 600 of the present invention implements step 103 and achieves the following objectives: (1) collecting different F&A items from different sources that match the personal fashion collection of end-users 311; (2) enabling try-on services of those different F&A items; (3) enabling online purchase of selected F&A items that fashionably and physically fit end-users 311; and (3) enabling convenient virtual purchase of those F&A items, all at the fingertips on the communication devices of end-users 311.

Now referring to FIG. 7, a virtual try-on module 700 in accordance with an exemplary embodiment of the present invention is illustrated. As described above, virtual try-on module 700 allows end-users 311 to try-on selected F&A items on their communication devices. In other words, virtual try-on module 700 provides clothes fitting services using machine learning algorithms and presents the fitting results on the communication devices of end-users 311. Virtual try-on module 700 includes communication links 701, a fashion and apparel (F&A) database 710, a user measurement predictor unit 721, a user posture in images or videos 722, a user body parts segmentation unit 723, an intermediate body measurement result unit 724, a F&A size selector 725, a body shape removal unit 726, a sparse keypoint detector 727, a dense keypoint detector 728, a virtual try-on machine learning unit 729, a retailer/seller server 730, and user communication devices 731. All listed components are connected as shown in FIG. 7 and operate as described in FIG. 2-FIG. 4 above. More particularly, the operations of virtual try-on module 700 is divided into two separate methods. In the first method, F&A items are retrieved from F&A collection storage 710 and input into user measurement estimator 721 which estimates the body size of end-users 311 using one of the following comparison methods: a mean or maximum values of all measurements, changes between subsequent measurements, conditional measurements, and growth curve parameters. After the body size has been predicted, user measurement predictor 721 either (1) reconstructs the 3D parametric body model of end-users 311 that includes estimated measurements; and/or (2) uses 2D heat map to provide the measurements between the coordinates (x,y) of joints or pivot keypoints. The results of user measurement predictor 721 may include different sizes and measurements. F&A size selector 725 is operative to select the proper size and measurements of end-users 311. Then, Virtual try-on machine learning unit 729 tailors and mounts the selected F&A items onto the parametric body model of end-users 311. The result can be tracked and rotated 360° so that end-users 311 can perceive the fitting of the selected F&A items. Finally, the try-on results are sent and stored in store server 730 for future uses and commercial purposes.

Continuing with FIG. 7, in the second method, the entire body measurement process as described in method 200 in FIG. 2 is performed in virtual try-on module 720. Specifically, body measurement module 400 provides the 3D body model and measurements of end-users 311. From user image/video input unit 722, user body part parsing unit 723 detects a particular end-user 311. A user image background segmentation unit 726 cuts and removes the particular end-user 311 from the background and/or other peoples in the photo and video. Intermediate measurement unit 724 performs the regression which includes sparse keypoint detection, dense keypoint detection on the body measurements to generate 2D pivot sparse keypoint. Then, sparse pivot keypoint unit 727 and dense pivot keypoint unit 728 can be used to reconstruct the 3D body model and measurements. In various embodiments, virtual try-on machine learning unit 729 generates tracked and 360° rotated views of the selected F&A items put on the 3D body model and measurements. The final fitting results are stored in store server 730 and exchanged with end-users 731 via connections 701 upon requests by end-users 731. In various embodiments of the present invention, body measurement module 400 includes a 2D heat map that is used to provide measurements between coordinates (x,y) of keypoints or joints.

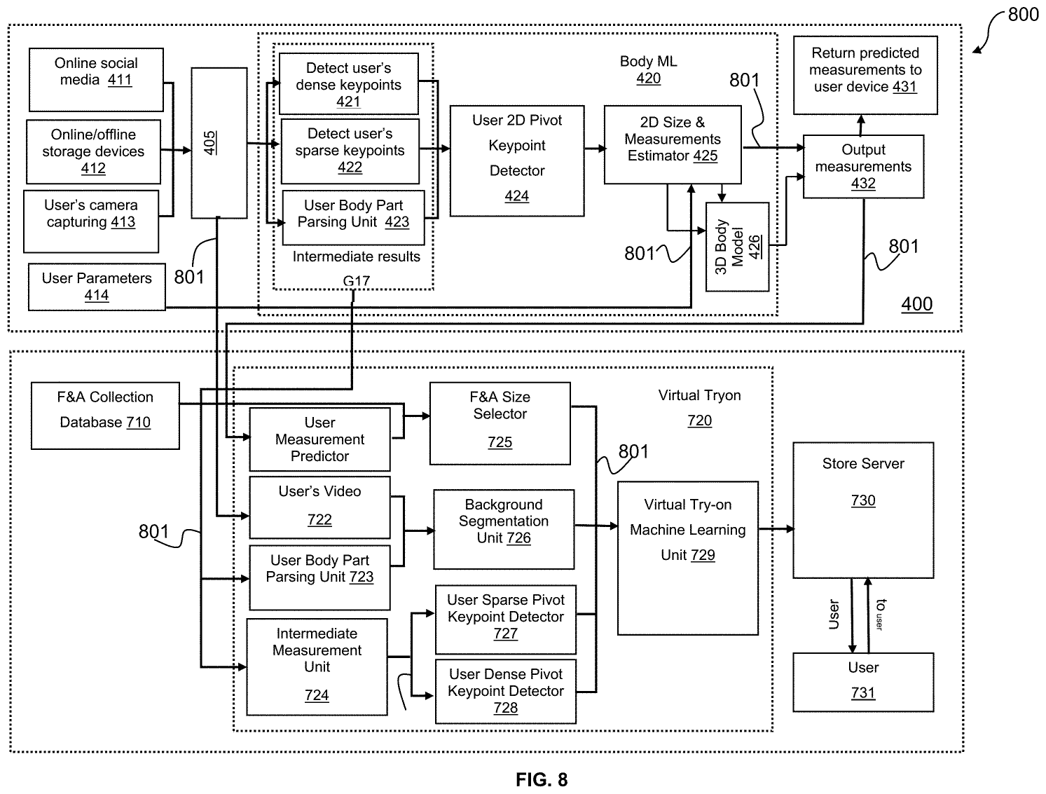

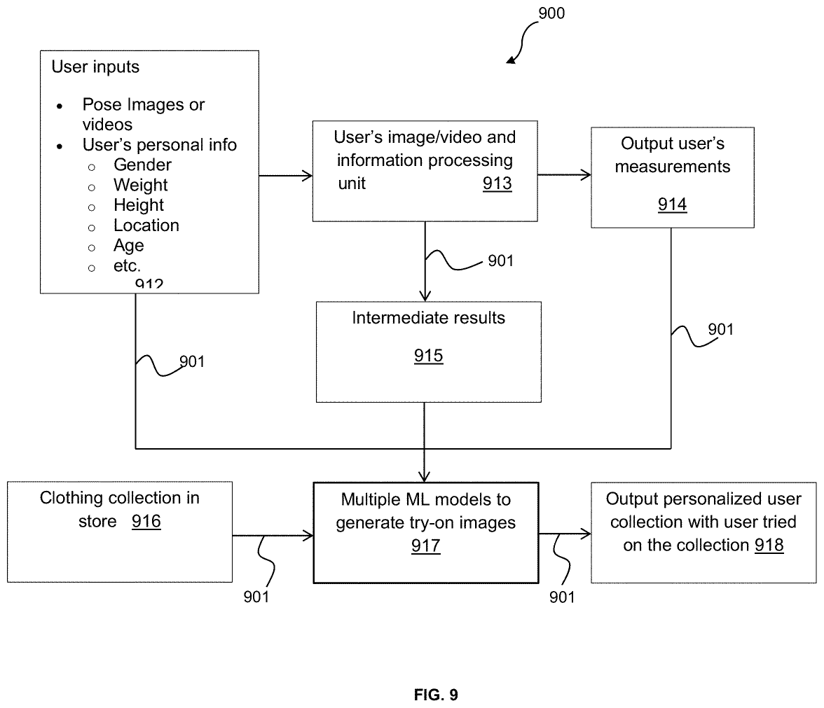

Referring to FIG. 8 which illustrates a diagrammatic representation of a measurement and try-on integration service module 800 (integration service module 800) between body measurement module 400 and virtual try-on module 700 in accordance with an exemplary embodiment of the present invention. In various embodiments, all components of integration service module 800 are connected together by communication links 801 and operate to obtain 3D model with measurements and virtual try-on as shown and discussed in FIG. 4 and FIG. 7 above. Communication links 801 that are connected all above items are either electrical connections, wireless connections, and/or flow directions of software subroutines. Integration service unit 800 as disclosed in the present invention achieves the following objectives:

(1) try-on or fitting service on the communication devices of different F&A items from various sources such as social media, online/offline databases, cameras, mix and match recommendation unit, personal fashion collections among end-users, etc.;

(2) tailor measurements are obtained from 2D heat maps or 2D sparse pivot keypoints without the need of 3D body model; and

(3) the body measurements and try-on results can be openly shared in a peer to peer connection among end-users which include buyers and retailers.

Referring next to FIG. 9, a block diagram of a high level virtual try-on module and the body measurement module 900 in accordance with another exemplary embodiment of the present invention is illustrated. High level virtual try-on module and body measurement module 900 is designed to accomplish multiple try-ons at once. Body measurement module 900 includes a user input unit 912, personal parameters and user images or videos 913, user measurement unit 914, a clothing unit intermediate results 915, a clothing collection in store data storages 916, a multiple machine learning try-on models and images 917, a user collection including try-on collections 918, all are connected as shown in FIG. 7 via a communication link 901 and operated as described in FIG. 2-FIG. 4 above. In many embodiments, communication link 901 includes wireless connections as listed above and/or software flow direction. High level virtual try-on module and the body measurement module 900 operates in two different routes. In the first route, user input unit 912 receives images or videos from end-users 311. In addition, parameters such as gender, weight, height, location, age, etc. are also provided to user input unit 912. The images/videos and parameters are processed in user's image/video and information processing unit 913 to generate either user's measurements in user measurement unit 914 the intermediate results including sparse keypoints, dense keypoints stored in intermediate results unit 915. The measurement results from user input unit 912, intermediate result unit 915, and user measurement unit 914 are input into multiple machine learning try-on unit 917. In the second route, clothing item collection from a retailer store 916 are also input into multiple machine learning try-on unit 917 to generate the entire personal try-on collections instead of a single try-on result as in in FIG. 7. That is, multiple machine learning try-on unit 917 is designed to dress the clothing item collection onto either user inputs from user input unit 912, intermediate results from intermediate result unit 915, and/or user output measurement 914. The end result is a multiple try-on results and not a single try-on at a time.

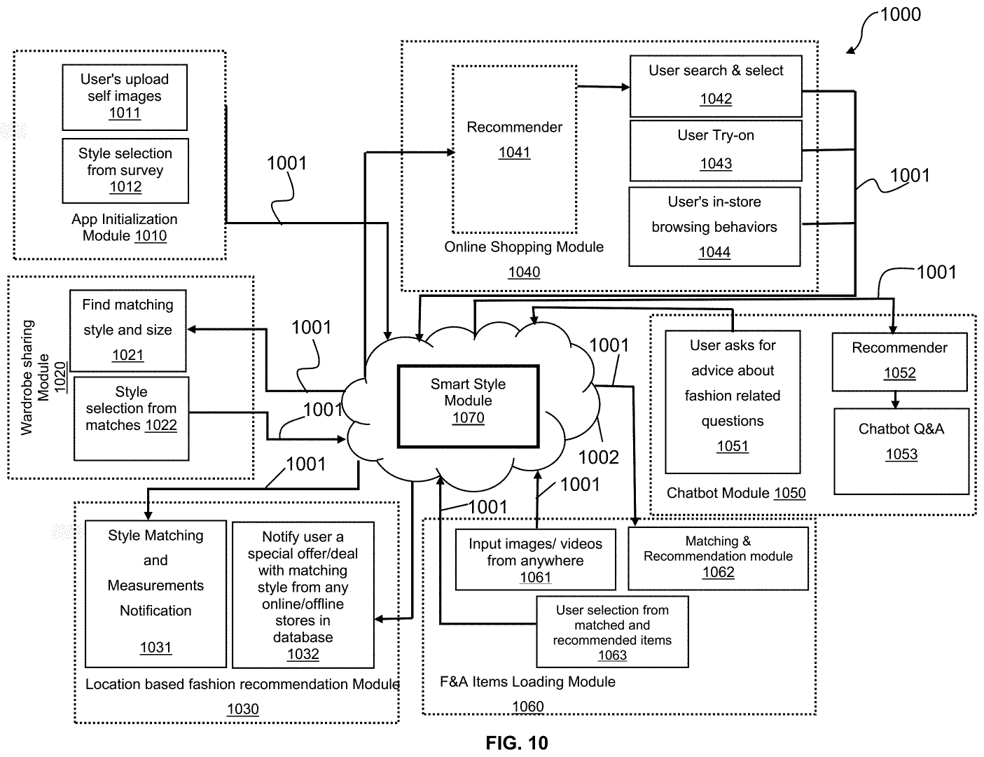

Referring to FIG. 10, a block diagram of a first shoot-it-wear-it-buy-it module 1000 in accordance with an exemplary embodiment of the present invention is illustrated. Shoot-it-wear-it-buy-it module 1000 allows end-users 311 to conveniently receive F&A items from various sources, try them on, and buy them in a smart style web-based module 1070 of the present invention. To achieve this objective, shoot-it-wear-it-buy-it module 1000 includes an application initialization module 1010, a wardrobe sharing module 1020, a fashion recommendation module 1030, an online shopping module 1040, a chatbot module 1050, and a fashion & apparel (F&A) loading module 1060. These units perform different functions of smart style web-based module 1070. It is noted that smart style web-based module 1070 can be either a webpage and/or a software application uploaded in a cloud-based network 1002.

Application initialization module 1010 includes a user image upload unit 1011, and a style survey selection unit 1012. After opening smart-style web-based module 1070, end-users 311 first initialize by logging in and authenticating to use the applications of the present invention, user image upload unit 1011 allows end-users 311 to upload their images or videos from various online/offline data storages. Style survey selection unit 1012 asks end-users 311 by presenting a set of questions including style, occasion, etc. Based on the answers provided, style survey selection unit 1012 displays a list of fashion and apparel (F&A) items of different styles so that end-users 311 can select.

Wardrobe sharing module 1020 allows sharing and exchanging of F&A items among end-users 311 by means of smart style web-based module 1070. That is, end-users 311 is enabled to move their F&A items into the sharing area of smart style web-based module 1070 which is viewed by other end-users 311 including buyers and retailers via communication links 1001. Wardrobe sharing module 1020 includes a style and size matching unit 1021, and a matching style selector unit 1022. Style and size matching unit 1021 finds all suitable F&A items that match the personal style and preference of a particular end-user 311. Matching style selector unit 1022 is a filter operative to select those F&A items that best suit a particular end-user 311.

Continuing with FIG. 10, location based recommendation module 1033 includes a style matching and measurement notification unit 1031 and a special deal and store location unit recommendation unit 1032. As their names suggest, style matching and measurement notification unit 1031 collects and matches all styles from all end-users 311 and retailers that are connected together via communication links 1001 and cloud-based network 1002. In addition, only those styles that seem to fit end-users 311 are presented. Special deals and store location unit 1032 collects all F&A items that match with those gathered from style matching and measurements notification unit 1031, presents the names and locations of all stores that are offering special deals for those F&A items.

Still referring to FIG. 10, online shopping module 1040 includes a recommendation unit 1041, a user search and selection unit 1042, a user try-on unit 1043, and a user in-store browsing behavior 1044. In operation, online shopping module 1040 allows end-users 311 to receive F&A recommendations from recommendation unit 1041 that retrieves F&A items from different sources such as wardrobe sharing module 1020, styles and discounts from location based recommendation module 1030, and survey selection unit 1012, etc. Then, recommended F&A items are searched and selected in user search and select unit 1042. The search results are tried on in a user try-on unit 1043 which operates as described in FIG. 7 and FIG. 8 above. The in-store browsing behaviors of end-user 311 are learned using machine learning algorithms executed by a user in-store browsing behavior unit 1044.

Referring again to FIG. 10, chatbot module 1050 also includes an F&A advising unit 1051, another recommendation unit 1052, and a chatbot and Q&A unit 1053. In operation, F&A advising unit 1051 provides specific advices of what F&A to wear to end-users 311 in response to the questions posted by end-users 311 on smart style web-based module 1070. Also, a chatbox (not shown) appears so as to answer all F&A questions from end-users 311. Then, recommendation unit 1052, based on the exchanged questions and answers, recommends specific F&A styles to end-users 311 who use chatbot Q&A unit 1053.

Still referring to FIG. 10, F&A items loading module 1060 includes a user input 1061, and a matching and recommendation unit 1062, a user selection unit 1063. As alluded above user input 1061 receives images/videos from all sources such as cloud storage, offline local databases, smart phone cameras, social media such as Facebook, Zalo, Twitter, Viber, Instagram, Weibo, etc. and posts them in smart style web-based module 1070. Matching and recommendation unit 1062 receives body measurements, virtual try-on image results, F&A style and trends, store locations, sales, rebases, and special deals, etc. and provides them to end-users 311. Finally, end-users 311 selects outputs from matching and recommendation unit 1062 and decides whether to buy them online.

From the above disclosure of the present invention, shoot-it-wear-it-buy-it module 1000 achieves the following objectives: (a) providing clothing fitness services use after receiving input images and personal parameters from users; (b) providing try-on services using the body model and measurements and input images of F&A items; (c) providing smart style web-based system by matching input images of F&A items extracted from past and current fashion and apparel (F&A) image files exchanged in a peer-to-peer manner among users and sellers; (d) providing a recommendation services to users by finding fashion trends, stores, locations, and suitable discounted prices.

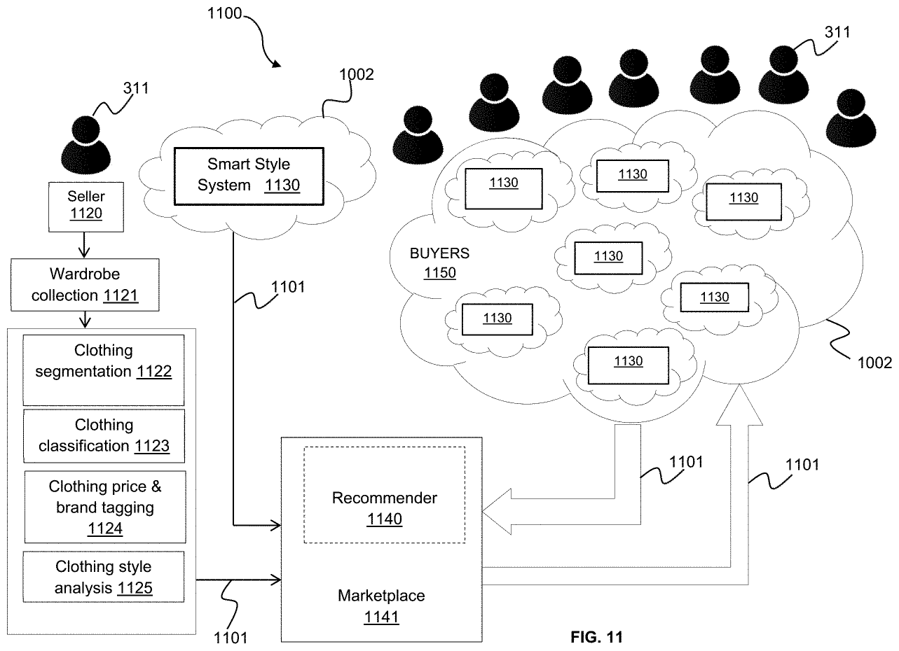

Referring now to FIG. 11, a perspective block diagram of a wardrobe sharing module 1100 that services end-users 311 in a peer-to-peer and open source blockchain formation in accordance with an exemplary embodiment of the present invention is illustrated. In wardrobe sharing module 1100, end-users 311 are further divided into F&A sellers 1120 and buyers 1150, all are connected together to a blockchain network 1002 via peer-to-peer communication links 1100. In various embodiments, wardrobe sharing module 1100 operates as a block chain network with peer-to-peer communication links 1101 including, but not limited to, peer-to-peer wireless connections, software flow directions, or the likes. A webpage 1130 having an internet protocol address (URL) which is used to receive sharing F&A items among buyers 1150 and/or sellers 1120. Sellers 1120 have a wardrobe collection unit 1121 which further includes a clothing segmentation unit 1122, a clothing segmentation unit 1123, a clothing price and brand tagging unit 1124, and a clothing style analysis unit 1125. It will be noted that wardrobe collection unit 1121 also includes other fashion and apparel items such as hats, shoes, scarves, gloves, watches, and anything related to fashion. Clothing segmentation unit 1121 segments different parts of clothing items such as shirts, pants, dresses, skirts, etc. using computer vision algorithms. While clothing classification unit 1123 groups clothing items into different categories such as sport wears, professional attires, social attires, casual attires, formal attires, hip-hop, etc. also using machine learning and computer vision algorithms. Clothing price and brand tagging unit 1124 adds prices and special occasion deals on each piece of clothing items. Clothing style analysis unit 1125 is a machine learning hardware/software that learns the fashion trends in a period of time. Market place 1141 is a server, connected to smart style webpage 1130, stores a recommendation module 1140. Recommendation module 1140 receives all the information from wardrobe collection 1121 and wardrobe sharing among buyers 1150. Using machine learning algorithms described in method 100, recommendation module 1140 recommends clothing items to buyers 1150 based on their style, collection, and browsing history. In other words, recommendation module 1140 receives shared fashion and apparel (F&A) collection among buyers 1150 and wardrobe collection from sellers 1120 and distributes these collections to the right buyers 1150 using peer-to-peer communication links 1101 and blockchain network 1002 in which end-users 311 represent complete nodes which obey the blockchain rules and regulations. That is, the shared personal wardrobe collections are encoded, immutable, and maintained in time series. End-users 311 come to agree whether a transaction is valid, what happens when changes need to be made to an existing blockchain of personal fashion collection deployment, and how permission works. In addition, end-users 311 cannot erase or alter the exchanged personal fashion collections. Each personal fashion collection transaction involves one or more addresses and a recording of what happened, and it is digitally signed. Blockchains are comprised of blocks, each block being a group of exchanged personal fashion collection transactions. All the transactions in a block are grouped together, along with a cryptographic hash of previous block. Finally, a new had is created for the curr3ent block's header to be recorded with the block data itself as well as within the next block. Over time each block is then chained to the previous block in the chain by adding the hash of previous block to the header of the current block. Marketplace 1141 is operative as an open ledger of blockchain wardrobe sharing module 1100.

Blockchain wardrobe sharing module 1100 achieves the following objectives of the present invention:

(1) smart fashion website 1130 configured to deliver all the fashion related services described in FIG. 1 readily to the fingertips of end-users 311 without having to go to the stores and to find these services at different places; and

(2) end-users 311 can openly share and exchange their personal fashion collections in a peer-to-peer manner; and

(3) personal fashion collections are secured and cannot be erased or altered.

FIG. 12-FIG. 21 illustrate the displays (front-ends) of a smart phone 1201 that shows the operations of system 300 and the implementations of methods 100 and 200 discussed in details above.

FIG. 12 shows the front-end display of the body measurement module that uses the artificial intelligence (AI) service of personal fashion coaching and assistance system in accordance with an exemplary embodiment of the present invention. FIG. 12 illustrates an implementation of step 102 (providing body measurement services, please refer back to FIG. 1), step 202 (receive user picture, personal parameters, and/or videos; please refer back to FIG. 2) which includes displays 1211-1218 realized by the execution of method 100 and method 200 embedded in the hardware/software of personal fashion and apparel (F&A) advising and coaching system 300. In display 1211, personal parameters such as gender, age (or birth year), height, weight, etc. are entered by end-users 311 after logging in into web-based smart fashion system 1070. In displays 1212-1214, an end-user 311 uses her smart phone 1201 to take a picture of herself in a virtual three-dimension dressing room 1212-1. A frame 1212-2 is used to align end-user 311 to the right position so that the best picture can be taken. In display 1215, end-user 311 positions herself in frame 1212-2 so that her feet and her back are at the back side of virtual dressing room 1212-1. In the next display 1216, end-user 311 turns on her side so that her left hand or her right hand is leaned against the back wall of virtual dressing room 1212-1. In display 1217, the two 2D pictures are reviewed. As end-user 311 presses a finish button 1217-1, artificial intelligence (AI) based service process 210 uses the input parameters and pictures 1215 and 1216 to reconstruct a 3D body model and measurements ready for virtual try-on performed by virtual try-on module 720.

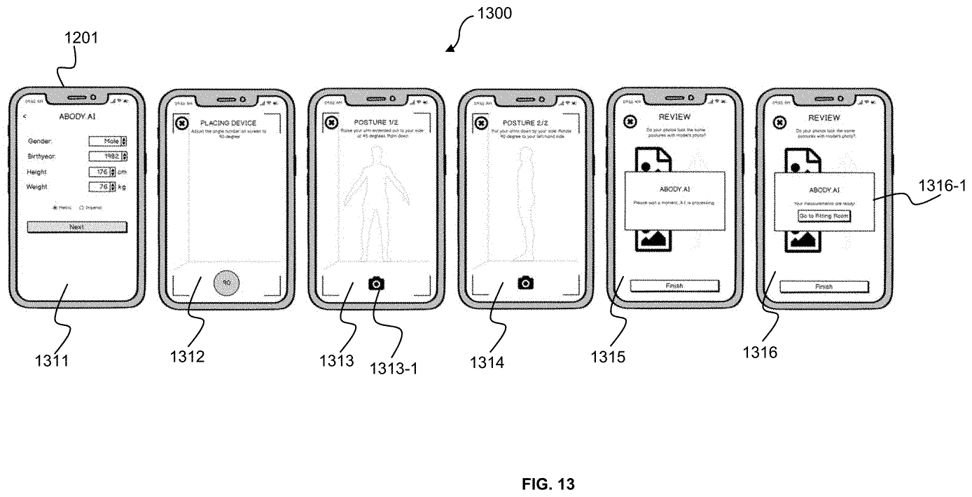

Referring next to FIG. 13, displays 1311 to 1316 illustrate a preferred method of taking and posting selfie pictures for body measurements and virtual try-on in accordance with an exemplary embodiment of the present invention. A display 1311 enables end-users 311 to enter their personal parameters. A display 1312 shows a 3D virtual dressing room 1312-1 and a frame 1312-2 for realigning the selfie picture. A camera icon 1313-1 is used to take the 2D pictures when end-users 311 are ready. Displays 1315 and 1316 are for reviewing and AI-based processing. Display 1311, display 1312, display 1313, display 1314, display 1315, and display 1316 are the results of system 300 and implementations of step 102 and method 200.

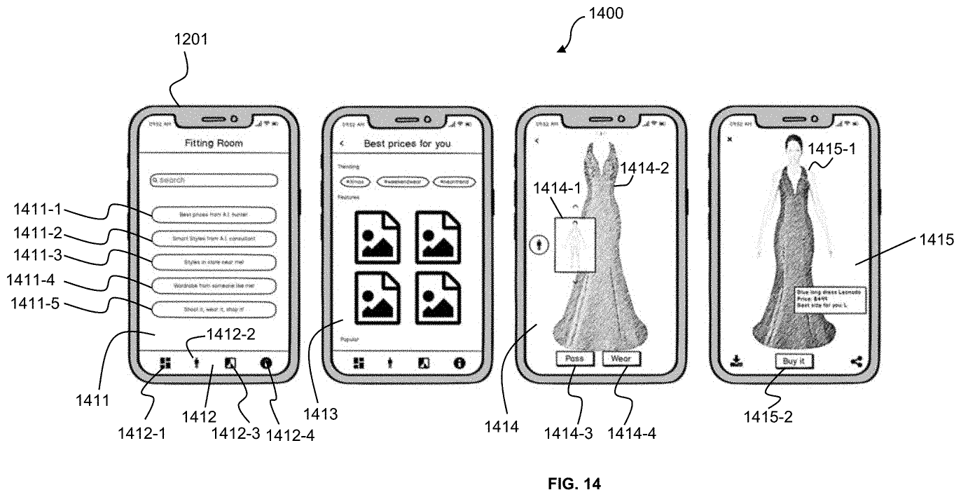

Next referring to FIG. 14, displays 1412-145 illustrate various aspects of the recommendation module of the present invention. More particularly, display 1412 shows the recommendations including a best price 1411-1, a smart style 1411-2, a store location 1411-3, wardrobe sharing 1411-4, and shoot-it-wear-it-buy-it 1411-5. Best price button 1411-1 illustrates step 105 which is implemented by recommendation units 334, 619, 1041, 1052, and 1062. Store location 1411-3 illustrates step or block 1032 which is implemented by recommendation units 334, 619, 1041, 1052, and 1062. Wardrobe sharing button 1411-4 illustrates step or block 1020 which is implemented by recommendation units 334, 619, 1041, 1052, and 1062. Shoot-it-wear-it-buy-it it button 1411-5 demonstrates F&A items loading module 1060. Next, a menu 1412, including a home button 1412-1, a body measurement button 1412-2, a try-on button 1412-3, and an information button 1412-4. Home button 1412-1 allows end-users 311 to escape from fitting room 1411 and return to home display screen (or desktop). Body measurement button 1412-2 starts the body measurement process as described in step 102 above. Try-on button 1412-3 begins the virtual try-on process as described in method 200 above. Information button 1412-4 starts user Q&A unit 1051 or chatbot Q&A unit 1053.

Continuing with FIG. 14, display 1414 illustrates the implementation of step 204 (virtual try-on an presents the results). A body measurement result screen 1414-1 presents the body measurement result. Image 1414-2 displays the fashion and apparel (F&A) item that end-users 311 choose. A reject button 1414-3 allows end-users to pass the recommended clothing item 1414-2 and try another one. Display 1415 illustrates the implementation of step 204 (virtual try-on an presents the results). Dress 1414-2 is fitted on the 3D body model and measurement and the result is displayed by image 1415-2. With this, end-users 311 can see how a particular clothing item fits. A “buy it” button 1415-2 allows end-users 311 (or buyers 1150) to purchase dress 1414-2 online.

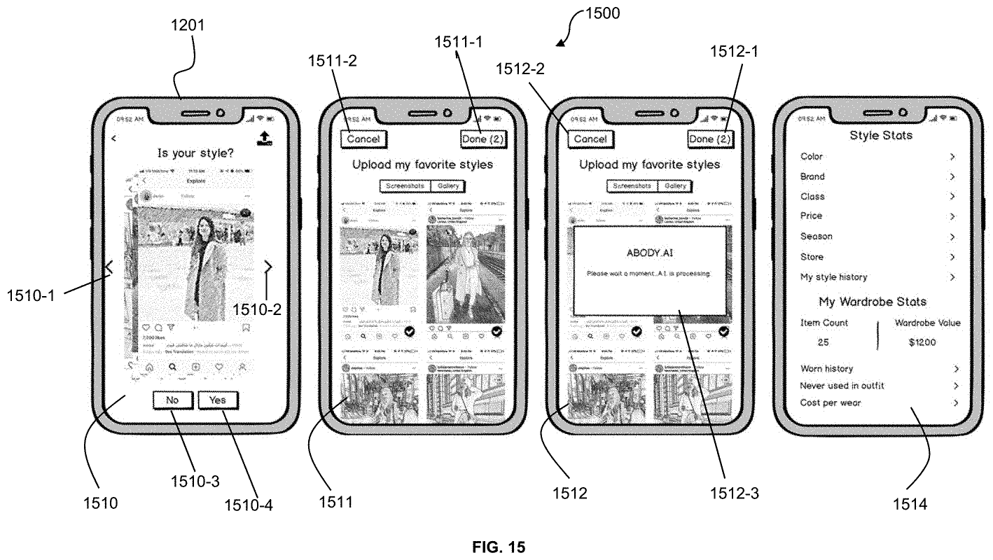

Referring next to FIG. 15, displays 1510 to 1514 illustrate various aspects of the style recommendation and price discount recommendations of the present invention. Display 1510 displays different styles that fit end-users 311 (or buyers 1150). A backward arrow 1510-1 and a forward arrow 1510-2 allow end-users to flip through a portfolio of style recommendation images. A “no” button 1510-3 and a “yes” button 1510-4 allows end-users to select or deselect a particular style. In a display 1511, all selected styles are displayed. End-users 311 has an option to either complete or cancel the style collection 1511 by using a “done” button 1511-1 or a “cancel” button 1511-2 respectively. In display 1512, all the selected style collections are displayed. If end-users 311 select done button 1512-1, recommendation system 334 starts to implement step 105 to find and recommend the prices, locations, and/or any discount offerings. The processing of artificial intelligence algorithms is displayed on an AI display 1512-3. In a display 1514, the results of recommendation unit 334 that performs step 105 are displayed.

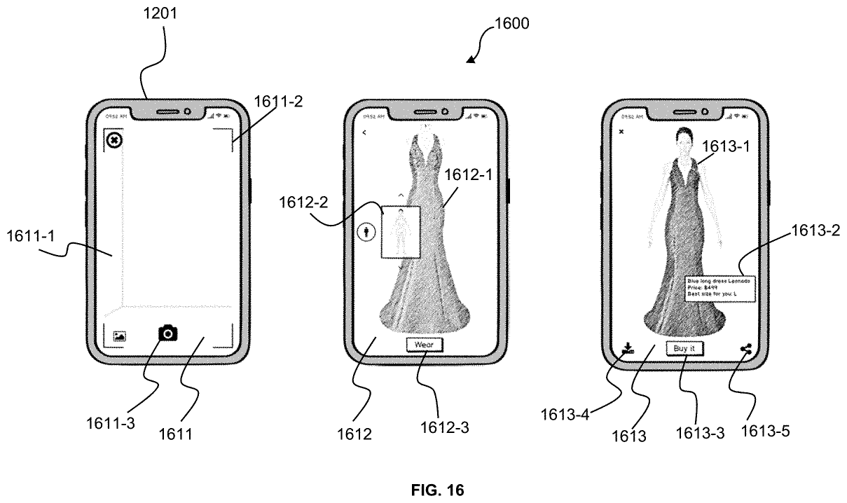

Next referring to FIG. 16, displays 1611-1613 illustrate the virtual try-on and display system of the present invention. Display 1611 presents a dressing room 1611-1, a frame 1611-2, and a camera button 1611-3. Display 1612 displays a recommended dress 1612-1 that fits personal collection, browsing habits, wardrobe sharing of end-users 311. A window 1612-2 displays the 3D body model and measurements. A wear button 1612-3 starts the virtual try-on process where recommended dress 1612-1 is put on 3D body model and measurements 1612-2. The image result is displayed by an image 1613-1. A brief description box 1613-2 lists all characteristics of recommended dress 1612-1, which includes color, price, style, size, stores nearby, etc. End-users 311 may share try-on image 1613-1 by pressing a share button 1613-4. Otherwise, end-users 311 may decide to down load try-on image 1613-1 onto smart phone 1201 by pressing a download button 1613-4.

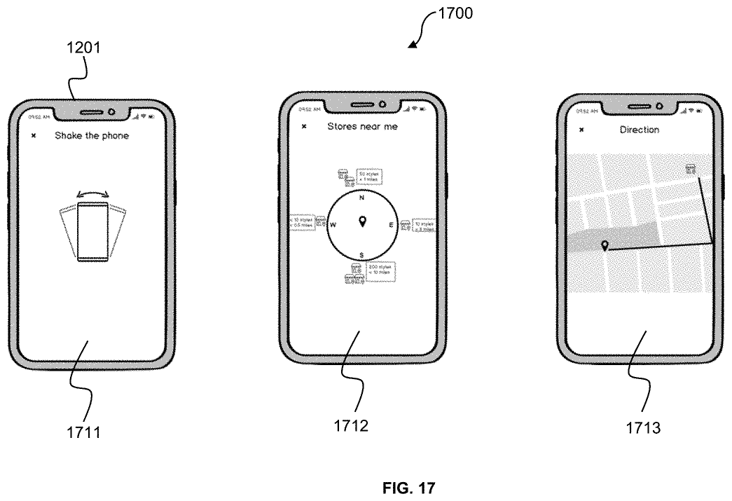

Next referring to FIG. 17, displays 1711-1713 illustrate another aspect of personal fashion and apparel (F&A) advising and coaching system 300 in accordance with an exemplary embodiment of the present invention. Display 1712, display 1713, display 1714 are the results of system 300 and implementations of step 102 and method 200. After end-users 311 presses a “buy-it” button 1613-3, display 1711 appears to show the store locations and directions. In many embodiments of the present invention, system 300 instructs end-users to shake smart phone 1201 from left to right. Next, display 1712 displays all nearby stores that offer recommended dress 1612-1. As end-users 311 select a store, system 300 presents a driving direction on a display 1713 using either Google map or a built-in geo position system (GPS).

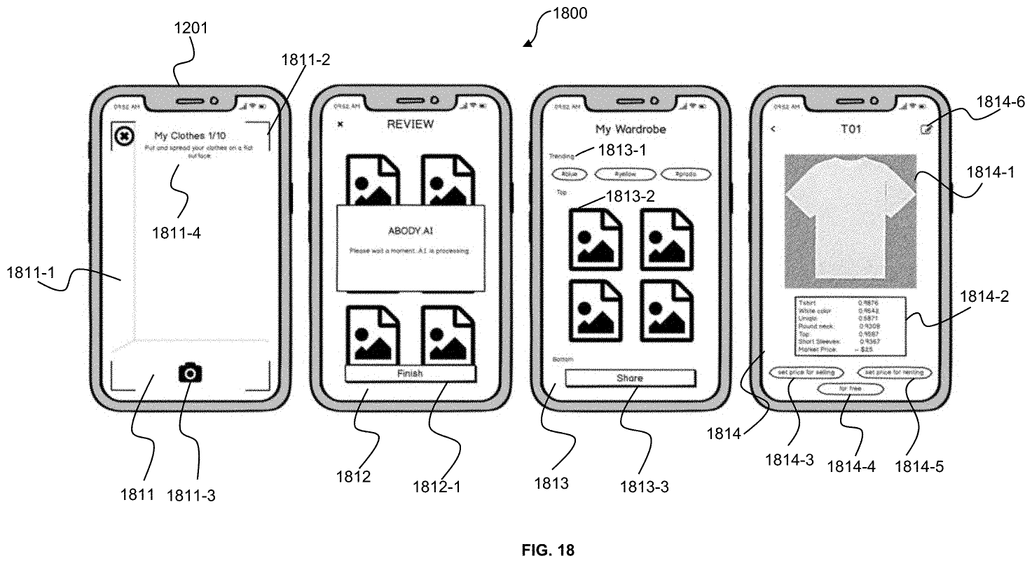

Referring to FIG. 18, displays 1811-1814 illustrates the uploading of a F&A item and the wardrobe collection and sharing the personal fashion coaching and assistance system in accordance with an exemplary embodiment of the present invention. Display 1811, display 1812, display 1813, and display 1814 are the results of system 300 and implementations of step 102 and method 200. Display 1811 shows a photo room 1811-1, a frame 1811-2, and a camera button 1811-3. Frame 1811-2 can be realigned by pressing down the finger and positioning it until the F&A item can be best represented and focused. Then camera button 1811-3 is pressed, the picture of a F&A item is taken. It is noted that end-users 311 can take the pictures of as many F&A items in their personal collection as they choose. In display 1822, all photos of F&A items are displayed for review. When a finish button 1812-1 is touched, display 1813 allows end-users 311 to share the personal F&A collection among themselves. Trending buttons 1813-1 allows end-users 311 to filter only a particular fashion trend such as athletic, casual, formal, etc. The review F&A items are displayed in a photo box 1813-2. A share button 1813-3 sends and shares the final collection among end-users 311. It is noted again that the wardrobe sharing is achieved in a peer-to-peer (P2P) and open source manner using the blockchain system. That is the sharing of wardrobe is encoded and time stamped so that the exchange F&A records can be used by other parties. Finally, when end-users 311 touch one of the pictures, a photo image 1814-1 of the F&A item is displayed. The description of the F&A item and measurements are included in a box 1814-2. The owner end-users 311 can: (1) set price for selling by pressing a sales button 1814-3; (2) give it for free by pressing a free button 1814-4; or (3) rent it at a set price by pressing a rent button 1814-5. Finally, an edit button 1814-6 allows the modification or the deletion of the F&A item.

FIG. 19 illustrates the front-end display of a webpage 1902 as another form implementing methods 100-200 and personal smart coaching and advising system 300 in accordance with an exemplary embodiment of the present invention. A display 1911, a display 1912, a display 1913, a display 1914 are the results of system 300 and implementations of step 102 and method 200. Display 1911 displays a webpage 1901 having an internet protocol (ip) address 1911-1. Webpage 1901 is a result of web-based smart style system 1130 which includes an input image 1911-2 of a F&A item, a brief description and measurements 1911-3, an upload button 1911-4, a try-on button 1911-5, a QR code of the F&A item 1911-6, and a blog button 1911-7. As end-users 311 press upload button 1911-4, page 1912 is displayed which includes a 2D front photo 1912-1, a 2D side photo 1912-2, and a parameter box 1912-3, a webcam photo button 1912-4, and an upload button 1912-5. Next, when 2D front photo 1912-1, 2D side photo 1912-2, and parameter box 1912-3 are completed, upload button 1912-4 begins method 200. As a consequence, 3D body model and measurements are reconstructed using convoluted neural network (CNN) as described in FIG. 2. Page 1914 displays the 3D body model and measurements 1914-1.

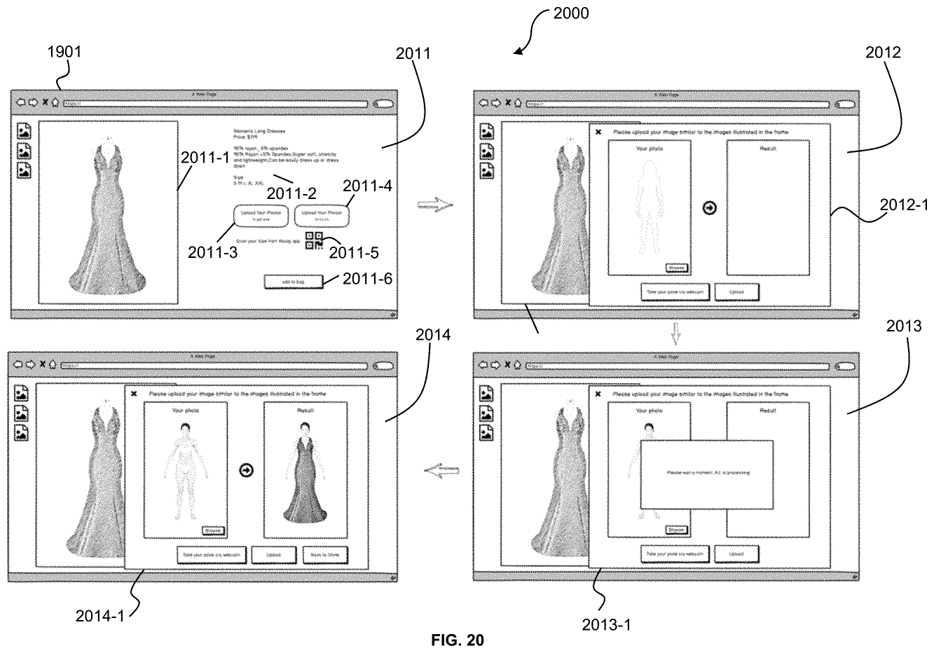

FIG. 20 illustrates the front-end display of webpage 1902 as another form implementing methods 100-200 and personal smart coaching and advising system 300 in accordance with an exemplary embodiment of the present invention. A display 2011, a display 2012, a display 2013, a display 2014 illustrate the operations of system 300 and implementations of step 102 and method 200. Display 2011 displays webpage 1901 having internet protocol (ip) address 1911-1 as shown in FIG. 19. Webpage 1901 is a result of web-based smart style system 1130 which includes an input image of a dress 2011-2, a brief description and measurements 2011-2, an upload button 2011-3, a try-on button 2011-4, a QR code of the F&A item 2011-5, and a blog button 2011-6. As end-users 311 press upload button 2011-4, page 2012 is displayed which includes a photo processing box 2013-1. Next, when complete, 3D body model and measurements are reconstructed using convoluted neural network (CNN) as described in FIG. 2. Page 2014 displays the 3D body model and measurements and virtual try-on result in a box 2014-1.

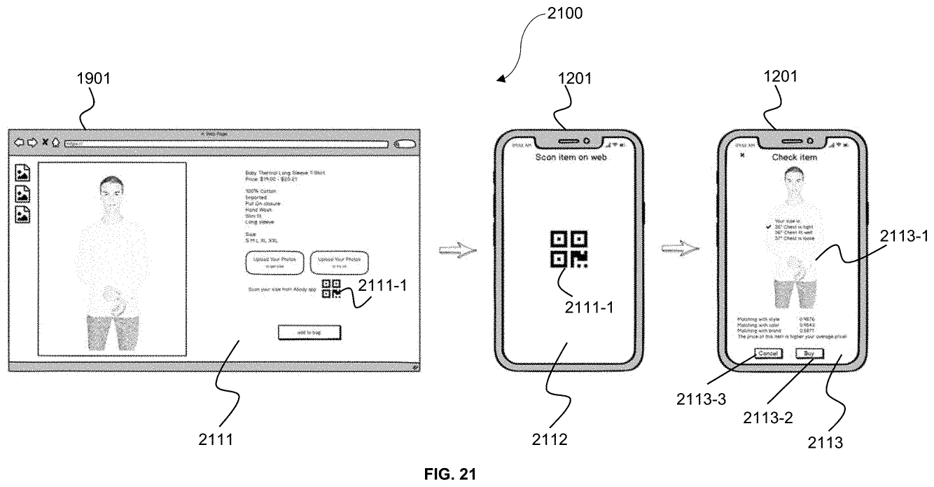

Finally referring to FIG. 21, a quick response (QR) code of a style formed by the smart style module of the AI service in accordance with an exemplary embodiment of the present invention. A display 2111, a display 2112, and a display 2213 are the results of system 300 and implementations of step 102 and method 200. Display 2111 is similar to display 1911 which is a smart style webpage. Smart phone 1201 is used to scan QR code 2111-1. As end-users 311 press on QR code 2111-1, F&A item including descriptions and personal parameters of end-users 311 are displayed on displayed 2113. A buy button 2113-2 allows end-users 311 to purchase the F&A item. A cancel button 2113-3 passes on the F&A item.

The above disclosure with reference to FIG. 1 to FIG. 21 discloses the following features of the present invention: (a) providing clothing fitting services use after receiving input images and personal parameters from end-users; (b) providing virtual try-on services using the body model and measurements and input images of F&A items; (c) providing smart style services by matching input images of F&A items extracted from past and current fashion and apparel (F&A) image files exchanged in a peer-to-peer manner among users and sellers; (d) providing a recommendation services to users by finding fashion trends, stores, locations, and suitable discounted prices; (e) all (a)-(d) features are at the fingertips and conveniences of the communication devices of end-users.

In implementations of FIG. 1 to FIG. 11 above, all the block diagrams can be hardware and/or software programming written in either WordPress, C, C++, Java, PHP, Pearl, Fortran, or Python programming languages. In terms of hardware requirements, the present invention uses a very efficient implementation of convolutional nets on 2 Nvidia GTX 580 GPUs (over 1000 fast little cores). The GPUs are used for matrix-matrix multiplies and also have very high bandwidth to memory. This allows AI service module 330 to train the neural network in a shortest of time. The neural network can be stretched over many cores if we can communicate the states fast enough. In the present invention, large neural network are used. Other models that use CNN such as ImageNet: ZFNet (2013), GoogLeNet (2014), VGGNet (2014), ResNet (2015), DenseNet (2016) etc. In various embodiments of the present invention, the hardware and software of FIG. 1 to FIG. 11 are implemented by either central graphic processing units (GPUs) and/or sharing GPU resources in a cluster mobile computing infrastructure among the communication devices of end-users 311 connected via a cloud-based network 302.

The computer program instructions executing methods 100 and 200 may also be stored in a computer readable medium that can direct a computer, other programmable data processing apparatus, or other devices to function in a particular manner, such that the instructions stored in the computer readable medium produce an item of manufacture including instructions which implement the function/act specified in the flowchart and/or block diagram block or blocks.

Artificial intelligence (AI) algorithms used in the present invention include, but not limited to, convolutional neural network (CNN), region-based convolutional neural network (R-CNN), Fast R-CNN, Faster R-CNN, regional proposal network (RPN), stacked auto encoders (SAE), deep learning tracker, fully-convolutional network tracker (FCNT) and multi-domain CNN (MD Net), and Mask R-CNN.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The disclosed flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### DESCRIPTION OF NUMERALS

| | |
|---|---|
| 300 | personal fashion coaching and assistance system |
| 301 | peer-to-peer (P2P) connections |
| 302 | network |
| 310 | frontend delivered to users in form of a website or API |
| 321 | input load balancer |
| 322 | end-user system |
| 323 | image databases |
| 324 | notification system |
| 325 | replicate databases |
| 326 | administrative management system |
| 330 | AI service module |
| 331 | body measurement module |
| 332 | virtual try-on module |
| 333 | smart style module |
| 334 | recommendation module |
| 340 | operating system (OS) |
| 341 | application delivery controller |
| 342 | logging system |
| 343 | security tracking system |
| 400 | body measurement module |
| 401 | communication links |
| 410 | input section |
| 411 | online social media |
| 412 | online/offline storage devices |
| 413 | user camera(s) |
| 414 | user parameters |
| 415 | user images or videos |
| 420 | body measurement machine learning (ML) module |
| 421 | dense keypoints detector |
| 422 | sparse keypoint detector |
| 423 | user body segmentation detector |
| 424 | 2D pivot keypoint detector |
| 425 | 2D measurements estimator |
| 426 | 3D body model (reconstruct) |
| 427 | intermediate result |
| 430 | output section |
| 431 | body measurement output unit |
| 432 | body measurement notification unit |
| 433 | virtual try-on module |
| 500 | keypoints localization |
| 510 | user body shape obtained from user photo or video |
| 501 | 2D pivot sparse key points |
| 600 | virtual try-on module using ubiquitous P2P network |
| 601 | P2P network connections |
| 602 | user images on databases |
| 603 | cloud-based network |
| 611 | online social media images |
| 612 | online/offline storage devices |
| 613 | camera units |
| 614 | images or videos loading unit |
| 616 | segmentation of clothing units and accessories |
| 617 | ML mixing and matching of clothing items |
| 618 | personal collection comparison unit |
| 619 | recommendation module |
| 620 | display and notification module |
| 621 | user selection unit |
| 622 | virtual try-on unit |
| 623 | display or notify try-on images to users |
| 624 | e-purchase unit |
| 700 | virtual try-on module |
| 701 | peer to peer connections |
| 710 | clothing collection in store database |
| 721 | user measurement predictor unit |
| 722 | user posture in images or videos |
| 723 | user body parts segmentation unit |
| 724 | intermediate body measurement result unit |
| 725 | F&A size selector |
| 726 | body shape removal unit |
| 727 | sparse keypoint detector |
| 728 | dense keypoint detector |
| 729 | user try-on fashion collection data storage |
| 730 | retailer/seller server |
| 731 | user communication devices |
| 800 | body measurement - virtual try-on integration service module |
| 801 | communication link, e.g., peer-to-peer connections |
| 900 | multiple body measurement module & virtual try-on module |
| 901 | communication link, e.g., peer-to-peer connections |
| 912 | user inputs and personal parameters |
| 913 | input processing unit |
| 914 | measurement output unit |
| 915 | intermediate result unit |
| 916 | store F&A collection |
| 917 | multiple ML model and measurements |
| 918 | virtual try-on unit |
| 1000 | shoot-it-wear-it-buy-it function module |
| 1001 | communication link, e.g., peer-to-peer connections |
| 1010 | application initialization module |
| 1011 | user image upload unit |
| 1012 | style selection unit |
| 1020 | wardrobe sharing module |
| 1021 | fashion style and size search engine |
| 1030 | location based fashion recommendation modu le |
| 1031 | style matching and measurement output unit |
| 1032 | discount and store location recommendation unit |
| 1040 | online shopping module |
| 1041 | recommendation unit |
| 1042 | user search and selection |
| 1043 | user try-on unit |
| 1044 | user in-store browsing behavior |
| 1050 | chatbot module |
| 1051 | user post |
| 1052 | recommendation unit |
| 1053 | chatbot Q&A unit |
| 1060 | F&A items loading module |
| 1061 | image and video input |
| 1062 | matching and recommendation module |
| 1063 | user selection unit |
| 1070 | smart style module |
| 1100 | wardrobe sharing module |
| 1101 | communication link e.g., peer-to-peer connections |
| 1102 | blockchain network |
| 1120 | seller/.retailers communication devices |
| 1121 | store wardrobe collection storage |
| 1122 | clothing segmentation unit |
| 1123 | clothing classification unit |
| 1124 | clothing price and brand tagging unit |
| 1125 | clothing style analysis unit |
| 1130 | web-based smart style module |
| 1140 | recommendation module |
| 1141 | market place |
| 1150 | buyers communication devices |
| 1201 | smart phone device |
| 1211 | personal parameters |
| 1212 | photo room display |
| 1213 | start timing display |
| 1214 | count down display |
| 1215 | front photo |
| 1216 | side photo |
| 1217 | processing page |
| 1217-1 | stop button |
| 1218 | fitting room page |
| 1411 | recommendation page |
| 1411-1 | best price button |
| 1411-2 | smart style button |
| 1411-3 | store nearby |
| 1411-4 | wardrobe sharing button |
| 1411-5 | shoot-it-wear-it-buy-it button |
| 1412 | function banner |
| 1412-1 | home button |
| 1412-2 | body measurement button |
| 1412-3 | virtual try-on button |
| 1412-4 | information button |
| 1413 | best price page listing all F&A items |
| 1414 | virtual try-on page |
| 1414-1 | 3D body model and measurements |
| 1414-2 | image of the F&A item |
| 1414-3 | refuse or “pass” button |
| 1414-4 | virtual try-on button |
| 1510 | fashion recommendation page |
| 1510 | first recommended F&A item |
| 1510-1 | backward button |
| 1510-2 | forward button |
| 1510-3 | refuse or “no” button |
| 1510-4 | select of “yes” button |
| 1511 | collection of all F&A styles |
| 1511-1 | completion or “done” button |
| 1511-2 | discard or “cancel” button |
| 1512 | fashion analytics page |
| 1512-1 | completion or “done” button |
| 1512-2 | discard or “cancel” button |
| 1512-3 | processing box |
| 1514 | statistics box |
| 1201 | smart phone |
| 1611 | photo page |
| 1611-1 | photo room |
| 1611-2 | photo frame |
| 1611-3 | camera button |
| 1612 | F&A item photo, e.g., formal dress |
| 1612-1 | F&A item, e.g., formal dress |
| 1612-2 | 3D body model and measurements |
| 1612-3 | try-on button |
| 1613 | result of dress fitting page |
| 1613-1 | the image of the virtual try-on |
| 1613-2 | description of the F&A item |
| 1613-3 | buy it button |
| 1613-4 | down load button |
| 1613-5 | share icon |
| 1711 | location finding page |
| 1712 | list of all retailers and addresses |
| 1713 | driving direction |
| 1811 | picture input page |
| 1811-1 | photo room |
| 1811-2 | picture frame |
| 1811-3 | camera button |
| 1812 | photo review page |
| 1812-1 | finish button |
| 1813 | wardrobe collection page |
| 1813-1 | trending display |
| 1813-2 | collection pictures |
| 1813-3 | share button |
| 1814 | result page |
| 1814-1 | F&A item photo |
| 1814-2 | description and size of the F&A item |
| 1814-3 | sale button |
| 1814-4 | donation button |
| 1814-5 | rent-out button |
| 1901 | webpage implementing method 100 and method 200 |
| 1911 | an F&A image page |
| 1911-1 | ip address of the F&A image page |
| 1911-2 | photo image of an F&A item |
| 1911-3 | description of the F&A item |
| 1911-4 | body measurement button |
| 1911-5 | virtual try-on button |
| 1911-6 | QR code of the F&A item |
| 1911-7 | blog button |
| 1912 | body model and measurement webpage |
| 1912-1 | front picture |
| 1912-2 | side or 90° picture |
| 1912-3 | personal parameters |
| 1912-4 | webcam button |
| 1912-5 | upload button |
| 2011-1 | input image of a dress |
| 2011-2 | description of the dress |
| 2011-3 | upload button |
| 2011-4 | virtual try-on button |
| 2011-5 | blog button |
| 2012-1 | AI photo processing box |
| 2013-1 | photo processing box |
| 2014-1 | try-on result box |
| 2111 | frontend display including a scanable QR code |
| 2111-1 | QR code of a specific F&A item |
| 2112 | display of QR code of a F&A item |
| 2113 | display F&A item and its descriptions |
| 2113-1 | image of the F&A item |
| 2113-2 | buy button |
| 2113-3 | cancel button |

1. A smart personal fashion coaching and assistance system, comprising:
a plurality of end-user communication devices each having at least one user databases;
a plurality of seller communication devices each having at least one seller data storages;
a network operable to connect and enable said plurality of end-user communication devices and said plurality of seller communication devices to freely exchange past and current fashion and apparel (F&A) image files; and
an artificial intelligence (AI) based fashion server operable to provide body measurements, virtual try-on, mix and match fashion and apparel (F&A) articles recommendations, and store and discount recommendations said plurality of end-user communication devices using deep learning algorithms performed on said past and current fashion and apparel (F&A) image files; wherein said AI based fashion server further comprises:
an input load balancer operable to distribute incoming network traffics from said plurality of end-user communication devices and a plurality of seller communication devices to said AI-based fashion server;
an end-user system, coupled to said input load balancer, operable to authenticate said plurality of end-user communication devices;
an artificial intelligence (AI) service unit, coupled to said input load balancer and said end-user system, further comprising a body measurement module, a virtual try-on module, a smart style module, and a recommendation module;
at least one image databases, coupled to said end-user system and said AI service unit, operable to store input images to and from said plurality of end-user communication devices;
at least one replicate databases, coupled to said end-user system, operable to store said open records of said past and current fashion and apparel (F&A) image files exchanged in a peer-to-peer manner;
an output load balancer operable to efficiently distribute outgoing network traffics from said AI-based fashion server to said plurality of end-user communication devices and said plurality of seller communication devices;
an administrative management system, coupled to manage said input load balancer, said at least one replicate databases, said AI service unit, said output load balancer, and said end-user system;
a notification system; coupled to said end-user system and said administrative management system; operable to notify said plurality of end-user communication devices when said past and current fashion and apparel (F&A) image files are exchanged in said peer-to-peer manner; and
an operating system (OS), coupled to said administrative management system, operable to replicate, track, and provide securities to said open records of said past and current fashion and apparel (F&A) image files.

2. The system of claim 1 wherein said network connects plurality of end-user communication devices and said plurality of seller communication devices in a peer to peer manner.

3. (canceled)

4. The system of claim 1 wherein said operating system further comprises:
a application delivery controller (ADC) operable to monitor and manage incoming and outgoing network traffics of said AI-based fashion server;
a logging system operable to manage and keep tracks of log-ins of said plurality of end-user communication devices; and
a security tracking system operable to replicate, track, and provide said securities to said open records of said past and current fashion and apparel (F&A) image files.

5. The system of claim 4 wherein said plurality of user communication devices further comprises a smart phone, a smart camera, a tablet, a laptop, a virtual reality (VR) device, an augmented reality (AR) device, and a desktop computer.

6. The system of claim 4 wherein said network comprises an internet, a cloud network, a local area network (LAN), a wide area network (WAN), a Wi-Fi, a Bluetooth, a Zigbee, and a Near Field Communication (NFC) system.

7. The system of claim 4 wherein said body measurement module further comprises:
a body part parsing unit operable to detect different body parts based on input images of a user;
a dense keypoint detector operable to detect features descriptive of each of said different body parts;
a sparse key point detector operable to detect outer shapes of each of said different body parts;
a two-dimension pivot keypoint detector operable to receive said dense keypoints, said sparse keypoints to detect locally descriptive features of each of said different body parts;
a three-dimensional pivot keypoint detector operable to receive said dense keypoints, said sparse keypoints, said 2D pivot keypoints, personal parameters to construct a 3D body measurement model for said user using a convolutional neural network regressive algorithm.

8. The system of claim 7 wherein said virtual try-on module further comprises:
a fashion and apparel (F&A) segmentation unit operable to dissect different F&A units based on input images;
a dense keypoint detector unit operable to detect features descriptive of each of said different clothing units;
a sparse key point detector unit operable to detect outer shapes of each of said different clothing units;
a two-dimension pivot keypoint detector unit operable to receive said dense keypoints, said sparse keypoints to detect locally descriptive features of each of said different clothing units;
a three-dimensional pivot keypoint detector operable to receive said dense keypoints, said sparse keypoints, said 2D pivot keypoints, personal parameters to construct a 3D model for each of said different clothing units using said convolutional neural network regressive algorithm; and
a virtual try-on machine learning unit operable to map said 3D model for each of said different clothing units onto said 3D model and measurements for said user.

9. The system of claim 8 wherein said further comprises:
a clothing style analysis unit operable to select different fashion and apparel (F&A) units based on a fashion collection of end-users; wherein said fashion collection is openly exchanged among said plurality of end-user communication devices and said plurality of seller communication devices in said peer-to-peer manner and extracted from said past and current fashion and apparel (F&A) image files; and
a display unit operable to display said different clothing units in accordance to said fashion collect of said end-users.

10. The system of claim 9 wherein said recommendation module further comprises:
a fashion style and size matching unit operable to search for store locations and discounts for said different clothing units selected by said end-users; and
wherein said fashion style and size matching unit is configured to enter and collect fashion trends based on said past and current fashion and apparel (F&A) image files stored in said at least one replicate databases and a social media.

11. (canceled)

12. (canceled)

13. (canceled)

14. (canceled)

15. (canceled)

16. (canceled)

17. (canceled)

18. (canceled)

19. (canceled)

20. (canceled)
